(19) United States
(12) Patent Application Publication
(10) Pub. No.: US 2026/0079121 A1
(43) Pub. Date: Mar. 19, 2026

(54) QUANTITATIVE MATERIAL CHARACTERIZATION METHOD AND SYSTEM BASED ON MULTI-ENERGY PHOTON AND NEUTRON INTERACTION RATIOS WITH REAL-TIME NOISE CORRECTION

(71) Applicant: Kairos Sensors LLC, Corvallis, OR (US)

(72) Inventors: Kendon Shirley, Corvallis, OR (US); Abdulsalam Mohammed Alhawsawi, Riyadh (SA)

(21) Appl. No.: 19/220,880

(22) Filed: May 28, 2025

Related U.S. Application Data
(60) Provisional application No. 63/652,349, filed on May 28, 2024.
(60) Provisional application No. 63/710,680, filed on Oct. 23, 2024.

(51) Int. Cl. G01N 23/20066; G01N 23/046; G01N 23/083; G06N 3/08

(52) U.S. Cl. CPC G01N 23/20066; G01N 23/046; G01N 23/083; G06N 3/08; G01N 2223/423

(57) ABSTRACT

The present disclosure provides systems and methods for quantitative material characterization using multi-energy photon and neutron interactions are disclosed. Extending traditional dual-energy techniques, the disclosure utilizes multi-dimensional vector analysis from multiple energy bins to enhance material differentiation. The approach leverages distinct energy-dependent behaviors of photoelectric effect (PE), Compton scattering (CS), pair production (PP), Rayleigh scattering, and neutron interactions. By calculating differences, ratios, slopes, and vector angles and directions across energy channels, and constructing two-dimensional (2D) and three-dimensional (3D) vectors, unique material signatures are obtained. Vector angles and trajectories through quadrants correspond to materials like clock hands indicating time, demonstrating identification precision. The disclosure integrates neural networks trained on simulated data and incorporates real-time feedback loops correcting for dark current, noise, and detector drift before vector analysis. This eliminates Poisson and detector noise, ensuring vectors represent material signals matching simulation vectors.

### CROSS-REFERENCE TO RELATED APPLICATIONS

This application claims the benefit of U.S. Provisional Patent Application No. 63/652,349, filed May 28, 2024, entitled “Quantitative Material Characterization Method And System Based On Multi-Energy Photon And Neutron Interaction Ratios,” and U.S. Provisional Patent Application No. 63/710,680 , filed Oct. 23, 2024, entitled “Quantitative Material Characterization Method And System Based On Multi-Energy Photon And Neutron Interaction Ratios With Real-Time Noise Correction,” each of which is incorporated herein by reference in its entirety.

### TECHNICAL FIELD

This disclosure pertains to advanced imaging and material characterization techniques utilizing multi-energy photons and neutrons. The disclosure encompasses a broad range of modalities, including X-ray imaging such as Computed Tomography (CT), Dual-Energy CT (DECT), Multi-Spectral CT (MSCT), mammography, and tomosynthesis. The disclosure further extends to Single Photon Emission Computed Tomography (SPECT), Positron Emission Tomography (PET), visible photon imaging including Multi-Spectral Imaging (MSI), Hyper-Spectral Imaging (HSI), and Raman spectroscopy, Infrared (IR) imaging including multi-spectral applications, Near-Infrared (NIR) imaging including Light Detection and Ranging (LIDAR) and multi-spectral techniques, Ultraviolet (UV) imaging including multi-spectral imaging, Neutron imaging including Multi-Spectral Neutron Imaging and Neutron Tomography, and gamma spectroscopy.

The disclosure focuses on enhancing material identification and differentiation by analyzing the ratios, differences, slopes, angles, and directions of photon or neutron interaction mechanisms across multiple energy channels or bins. For photons, this includes interactions such as the photoelectric effect (PE), Compton scattering (CS), pair production (PP), and Rayleigh scattering. For neutrons, this includes elastic scattering, inelastic scattering, neutron capture, and neutron-induced fission.

By utilizing these ratio-metric, slope-based, angle-based, and direction-based analyses and constructing two-dimensional (2D) and three-dimensional (3D) vectors, the disclosure provides a quantitative metric for determining the electronic structure of a material, such as the atomic number (Z) or effective atomic number (Z_effective) of a compound material. This information finds use in various applications, e.g., medical imaging for soft tissue differentiation, security screening, non-destructive testing, and material science.

### BACKGROUND

Existing imaging methods, such as Dual-Energy Computed Tomography (DECT) and Multi-Spectral CT (MSCT), have made significant strides in material differentiation compared to conventional CT. These techniques leverage the energy-dependent attenuation of X-rays by acquiring images at two or more energy levels. By analyzing the differences in total attenuation across these energy levels, DECT and MSCT can distinguish between materials with varying densities and effective atomic numbers (Z_effective), providing valuable information for applications such as bone mineral density assessment and contrast agent visualization.

However, these methods face several limitations in accurately differentiating materials with similar densities but distinct compositions, particularly in soft tissues. Material similarity presents difficulty in accurately differentiating materials with similar densities but distinct compositions. The focus on total attenuation alone does not provide a complete picture of underlying photon interactions. The complex interplay between the photoelectric effect (PE), Compton scattering (CS), and pair production (PP) significantly influences the material-specific response to X-rays, which total attenuation does not fully capture.

Current methods also depend on digital pulse processing to differentiate materials effectively, which can be technically challenging and costly. Traditional photon counting methods are subject to Poisson statistical fluctuations due to random photon arrival times, limiting diagnostic accuracy particularly for low photon yields. Additionally, existing techniques often cannot provide detailed information about the electronic structure of materials, such as elemental composition.

Statistical noise presents another significant challenge. Traditional photon counting methods are subject to Poisson statistical fluctuations due to random photon arrival times, limiting diagnostic accuracy particularly for low photon yields. Moreover, existing techniques are often limited in their ability to provide detailed information about the electronic structure of materials, such as their elemental composition or chemical bonding.

Accurate material characterization is crucial in various fields. In medical imaging, there is a need for differentiating between healthy and diseased tissues, early cancer detection, precise localization of abnormalities, and quantitative assessment of contrast agents. Security screening requires identifying hazardous materials, explosives, and special nuclear materials (SNMs). Material science and engineering applications need understanding of material properties, quality control, and non-destructive testing. Resource exploration demands analyzing geological samples for mineral content.

### SUMMARY

The present disclosure addresses these limitations by introducing a novel approach that goes beyond total attenuation analysis. By explicitly calculating and utilizing the differences, ratios, slopes, angles, and directions of different photon or neutron interaction mechanisms across multiple energy bins, and constructing 2D and 3D vectors, the disclosure unlocks a new dimension of information that enables more accurate, sensitive, and quantitative material characterization.

For example, the present disclosure provides, in at least one aspect, methods for quantitative material characterization comprising directing photons or neutrons at a material; detecting and measuring interactions of the photons or neutrons with the material at two or more distinct energy channels to obtain interaction counts; correcting the measured interaction counts for dark current, noise, and detector drift using a real-time feedback loop; calculating ratios of differences between different interaction mechanisms across the energy channels (for photons the interaction mechanisms comprise photoelectric effect, Compton scatter, and pair production; and for neutrons the interaction mechanisms comprise elastic scattering, inelastic scattering, neutron capture, and neutron-induced fission); analyzing slopes, angles, and directions of vectors constructed from the interaction counts; and using the calculated ratios, slopes, angles, and directions to identify and quantify the material.

In some embodiments, methods further comprise selecting multiple pairs of energy bins across different interaction regions; extracting counts from each energy bin and correcting for noise and drift; calculating differences to form components of vectors; constructing two-dimensional (2D) and/or three-dimensional (3D) vectors representing material interactions; and computing effective ratios, magnitudes, angles, and directions of the vectors.

In some embodiments, methods further comprise utilizing energy integration techniques to measure total energy deposited across energy bins; implementing the real-time feedback loop to correct for dark current, noise, and detector drift; reducing noise and improving signal-to-noise ratio; applying integrated and corrected data to enhance material characterization; and stabilizing vector angles and directions for accurate material identification.

In some embodiments, methods further comprise training neural networks on vectors constructed from simulated multi-energy bin counts, their angles, and directions; incorporating detector characteristics into simulations to accurately model responses; utilizing real-time noise correction to align actual measurements with simulated data; and applying trained models to classify materials based on interaction signatures reflected in vector angles and directions.

In some embodiments, methods further comprise applying multi-dimensional vector analysis, angle, and direction measurements to imaging data; correcting measurements for noise and drift using the real-time feedback loop; differentiating tissues based on unique interaction signatures and vector trajectories; and utilizing the method for improved diagnostic accuracy in medical imaging.

In some embodiments, methods further comprise using vector analysis of the interactions, including angle and direction measurements, to detect and identify hazardous materials; implementing real-time noise correction to ensure accurate measurements; and integrating the method into security scanning systems for enhanced detection capabilities.

In some embodiments, methods further comprise applying vector analysis and angle and direction measurements to assess internal structures of materials without causing damage; correcting measurements for noise and drift to prevent misinterpretation; and identifying structural anomalies based on interaction signatures and changes in vector trajectories.

In some embodiments, methods further comprise incorporating additional energy bins to capture more complex interactions; correcting all measurements for noise and drift using the real-time feedback loop; and constructing higher-dimensional vectors and analyzing their angles and directions for improved material discrimination.

The present disclosure provides, in at least one aspect, systems for material characterization comprising a source of photons or neutrons configured to irradiate a material; a detector array configured to measure interactions at multiple energy levels; a real-time feedback loop for correcting measurements for dark current, noise, and detector drift; a processing unit configured to construct vectors, compute ratios, magnitudes, angles, and directions, and to compare them against a database of known material signatures; and software implementing neural networks trained on simulated data for analyzing the constructed vectors and their angles and directions, wherein the neural networks include an AI module configured to refine material identification accuracy based on iterative learning from new data.

In some embodiments, the source comprises a photon source and the interactions comprise photoelectric effect, Compton scatter, and pair production.

In some embodiments, the source comprises a neutron source and the interactions comprise elastic scattering, inelastic scattering, neutron capture, and neutron-induced fission.

In some embodiments, the system is configured for use in medical imaging, security screening, or material science.

The present disclosure provides, in at least one aspect, methods for identifying a material traversed by X-ray photons. For example, in some embodiments, methods comprise exposing a material to an X-ray source that emits a spectrum of photon energies; detecting attenuated X-ray signals using a detector comprising at least four energy channels, including a first pair of energy channels configured to measure photon interactions predominantly in the photoelectric effect (PE) region, and a second pair of energy channels configured to measure photon interactions predominantly in the Compton scatter (CS) region; calculating a first vector based on the difference in attenuated electron counts between the two PE energy channels, and calculating a second vector based on the difference in attenuated electron counts between the two CS energy channels; computing the angle between the first vector and the second vector; and identifying the material based at least in part on the angular relationship between the PE and CS vectors.

In some embodiments, the identification of the material is performed by a machine learning model trained using both simulated data representing X-ray photon interactions with single-material paths and simulated data representing X-ray photon interactions with multi-material, path-integrated tissue geometries, wherein said simulated data comprises angular vector relationships derived from the differences in attenuated electron counts across paired energy channels, and wherein the machine learning model is configured to infer dominant material identity based on the resulting angular distortions between the photoelectric and Compton scatter vectors.

In some embodiments, the identification of the material is based on a plurality of angular relationships, each computed from separate pairs of energy channels comprising a first photoelectric vector constructed from a first pair of energy channels in the photoelectric-dominated region, and a first Compton scatter vector constructed from a first pair of energy channels in the Compton scatter-dominated region, a second photoelectric vector constructed from a second pair of energy channels in the photoelectric-dominated region, and a second Compton scatter vector constructed from a second pair of energy channels in the Compton scatter-dominated region, wherein the second pair of energy channels is non-overlapping with the first pair of energy channels, computing a first angle between the first photoelectric and first Compton scatter vectors, and a second angle between the second photoelectric and second Compton scatter vectors, and identifying the material based at least in part on the combination of the first and second angles.

In some embodiments, the method further comprises generating a material composition image with spatially color-coded identity labels based on the identified materials.

The disclosure provides, in at least one aspect, display systems for visualizing material composition, comprising a processing module configured to receive input data comprising vector-based material identity information derived from photon interaction ratios across energy bins or spectral channels, a composition visualization module configured to generate a two-dimensional or three-dimensional image wherein spatial locations are color-coded based on identified material type, and an optional interface layer allowing said composition image to be displayed independently or superimposed onto a conventional grayscale or anatomical image, wherein the system supports input across a plurality of photon wavelength domains, including ionizing and non-ionizing spectra.

Other aspects of the disclosure will become apparent by consideration of the detailed description and accompanying drawings.

### BRIEF DESCRIPTION OF THE DRAWINGS

These and other features, aspects, and advantages of the present technology will become better understood with regards to the following drawings. The accompanying figures and examples are provided by way of illustration and not by way of limitation.

FIG. 1: Visual representation of the GATE simulation for a tungsten X-ray spectrum using a 120 kVp setting. The beam contains one million photons per square mm incident on MAPbBr3 perovskite material (the detector), with an area of 1 cm square, and a thickness of 1.7 mm. A PENELOPE physics package was utilized, showing photon interactions with the detector material.

FIG. 2: Simulation setup with adipose tissue (5 cm), cortical bone (0.4 cm), and iodine contrast (0.02 cm) placed between the X-ray beam and the MAPbBr3 perovskite material (directly adjacent), and a spectrum of the beam with and without said materials placed in front was measured to observe the on/off signal provided by the detector.

FIG. 3: Cortical bone simulation with material, beam, and detector dimensions.

FIG. 4: Mass attenuation coefficient curves as a function of photon energy, generated from NIST XCOM compound calculator. Adipose, cortical bone, and iodine curves are shown, and the difference between two different energy bins (25 keV and 35 keV) provide different amounts of attenuation (shown by the arrows) for a given material. This traditional method for DECT and MSCT provides the total attenuation difference between two energy channels that qualitatively relates (grayscale images) to a given material density.

FIG. 5: Shows three curves for adipose tissue: the mass attenuation coefficient as a function of energy for the (1) photoelectric effect, (2) Compton scattering, and (3) both curves combined. For a given photon energy, there is a probability of photon interaction that is from the photoelectric effect, and a probability of photon interaction that is from Compton scattering. When measuring at two points on the energy spectrum (Bin 1 and Bin 2), it creates a unique set of vectors for both effects. This combination of vector angles is specific to the electronic structure of a material, due to how the ratio of both effects relates to the specific electronic structure of a material.

FIG. 6: Shows three curves for cortical bone: the mass attenuation coefficient as a function of energy for the (1) photoelectric effect, (2) Compton scattering, and (3) both curves combined.

FIG. 7: Shows three curves for iodine contrast: the mass attenuation coefficient as a function of energy for the (1) photoelectric effect, (2) Compton scattering, and (3) both curves combined.

FIGS. 8A-8L: This composite figure illustrates various aspects of the energy spectrum and electron count distribution for MAPbBr3 when interacting with different materials: (FIG. 8A), (FIG. 8E), (FIG. 8I): The energy spectrum of an X-ray source and the resulting electron count distribution for MAPbBr3 when interacting with adipose tissue, cortical bone, and iodine, respectively. (FIG. 8B), (FIG. 8F), (FIG. 8J): The electron counts attributed to PE and CS for adipose, cortical bone, and iodine at two different energy channels. Vectors are shown between the energy channels for each effect (PE and CS). (FIG. 8C), (FIG. 8G), (FIG. 8K): The difference in electron counts (Δ) for PE and CS between the two energy channels for adipose, cortical bone, and iodine. (FIG. 8D), (FIG. 8H), (FIG. 8L): The ratios of differences (PE/CS) for adipose, cortical bone, and iodine.

FIGS. 9A-C: Composite figure illustrating energy spectrum and electron count distribution when adipose tissue (FIG. 9A), cortical bone (FIG. 9B), and iodine (FIG. 9C) are placed between the X-ray beam and the detector material. The curves, labeled “flood,” show the electron count as a function of energy when no photons have been attenuated. The difference between the flood and material curves provides the attenuation for a given photon energy.

FIGS. 10A-L: Comparison of electron counts for different materials, showing the distribution of counts across energy bins and ratios of differences for adipose tissue, cortical bone, and iodine. FIGS. 10A to 10L show the electron counts attributed to photoelectric effect (PE) and Compton scattering (CS) at two different energy channels, the attenuated electron counts attributed to photoelectric effect (PE) and Compton scattering (CS), the difference (Δ) in electron counts between the two energy channels for the photoelectric effect (PE) and Compton scattering (CS), and the ratio of the differences (PE/CS) in electron counts for adipose (FIG. 10A to FIG. 10D, respectively), cortical bone (FIG. 10E to FIG. 10H, respectively), and iodine (FIG. 10I to FIG. 10L, respectively). In FIGS. 10A, 10E, and 10I, vectors are shown between the energy levels for each effect (PE and CS).

FIG. 11: 2D Hypotenuse Resultant Vectors, Angles, and Quadrant Information for Adipose, Cortical Bone, and Iodine, illustrating the unique vector signatures achieved when making the PE and CS vectors orthogonal to each other.

FIG. 12: Mass energy-absorption coefficient as a function of energy (30 keV to 100 keV) for two similar density soft tissues: adipose tissue (ICRU-44) and breast tissue (ICRU-44).

FIG. 13: Vectors (V1-V4) for the two materials described in FIG. 12. V1 is the PE vector and V2 is the CS vector for breast tissue (ICRU-44), and V3 is the PE vector and V4 is the CS vector for adipose tissue (ICRU-44). These vectors are shown on a clock face to illustrate the clock analogy, demonstrating how the angles of the vectors in relation to each other can differentiate similar density materials.

FIGS. 14A-C: This figure compares attenuated electron counts for three materials-Adipose, Cortical Bone, and Iodine-across two energy segments (30-35 keV and 40-45 keV). Subplot (FIG. 14A): Monte Carlo simulations were performed using GATE (a Geant4-based platform) with the PENELOPE physics package to accurately model radiation transport and interactions. Adipose, cortical bone, and iodine were placed between the X-ray source and the perovskite detector (MAPbBr3). To quantify photon attenuation, the electron counts recorded with the material in place were subtracted from those recorded without material. This subtraction, measured across four energy bins, yielded the number of electrons corresponding to the attenuated photons. For visualization, these attenuation electrons were joined as a line vector at the two lower energy bins, and the same process was repeated for the two higher energy bins, creating two sets of vectors for each material. Subplot (FIG. 14B) vectors are then shifted so that the endpoints at 35 keV and 40 keV intersect at a (0,0) point of origin, emphasizing angular differences between the materials. Subplot (FIG. 14C) the shifted vectors are scaled to fit a circular “clock” representation, preserving slopes and angular relationships for intuitive visual comparison.

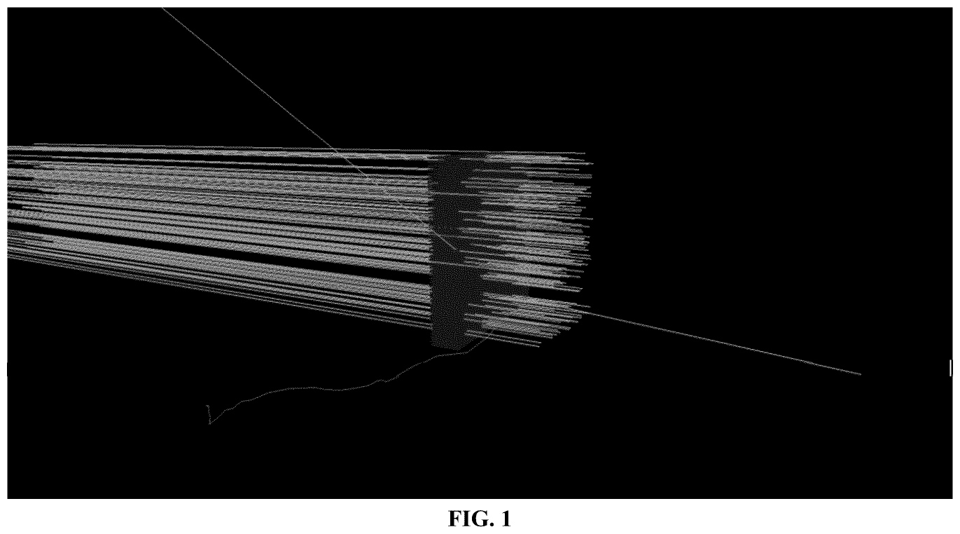

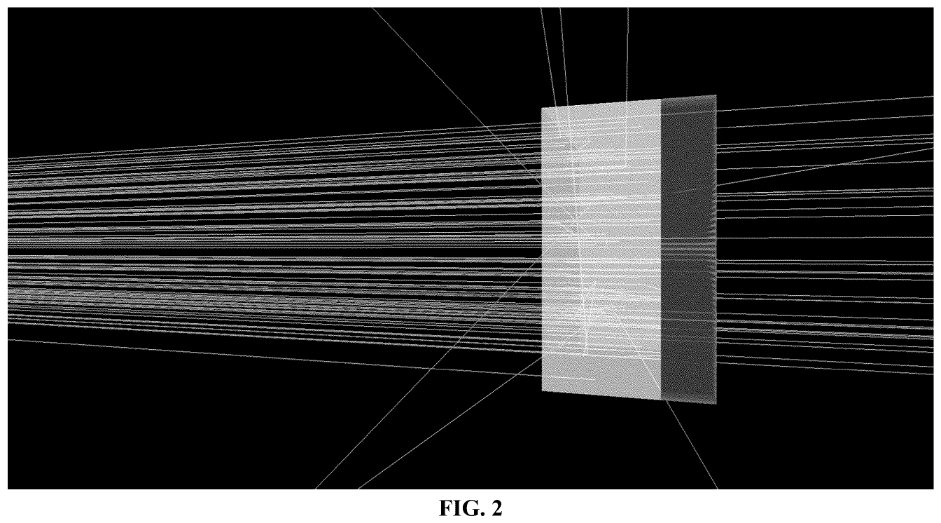

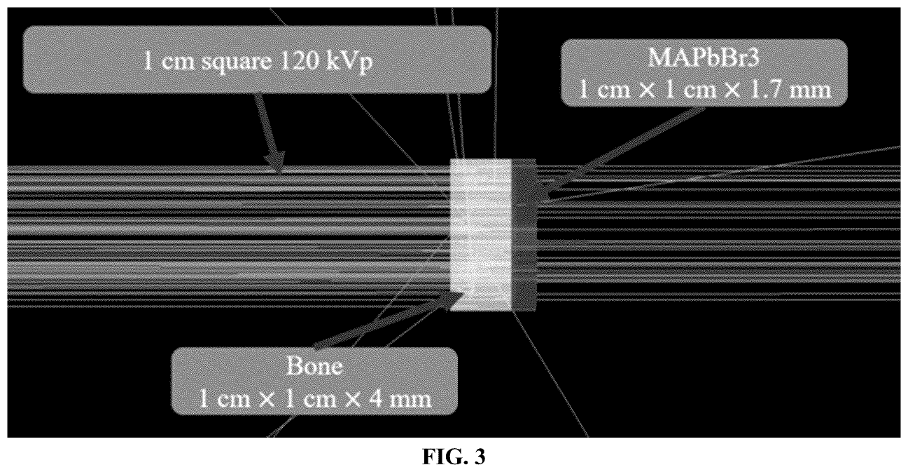

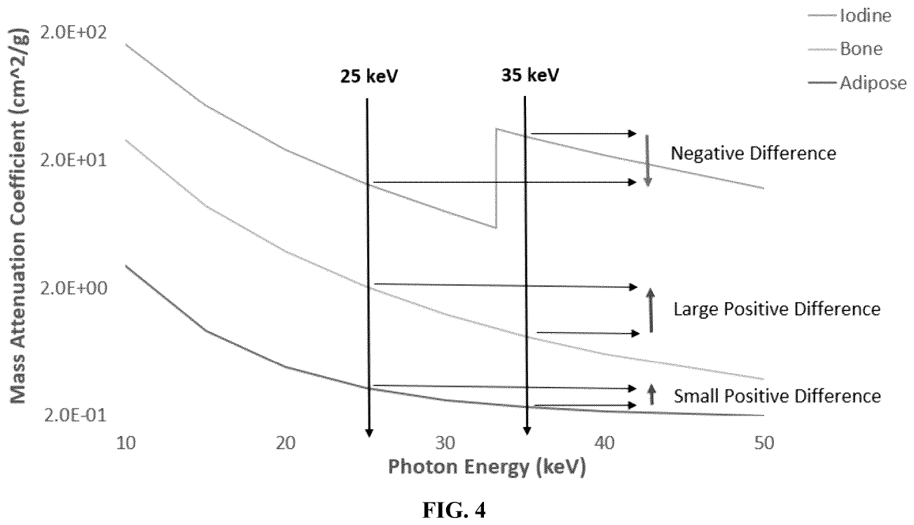

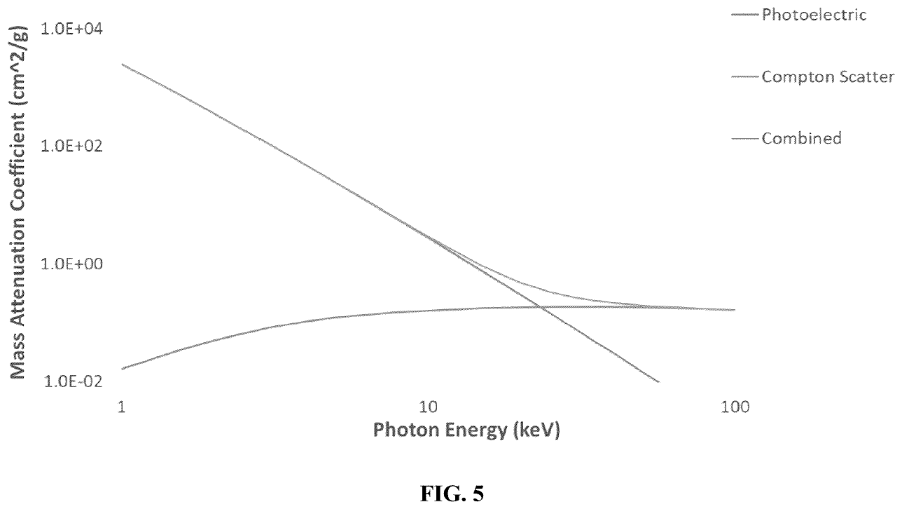

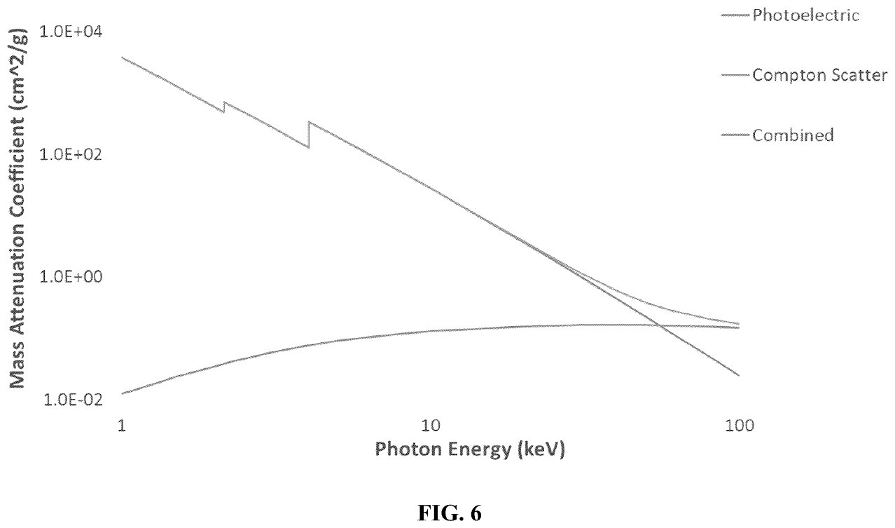

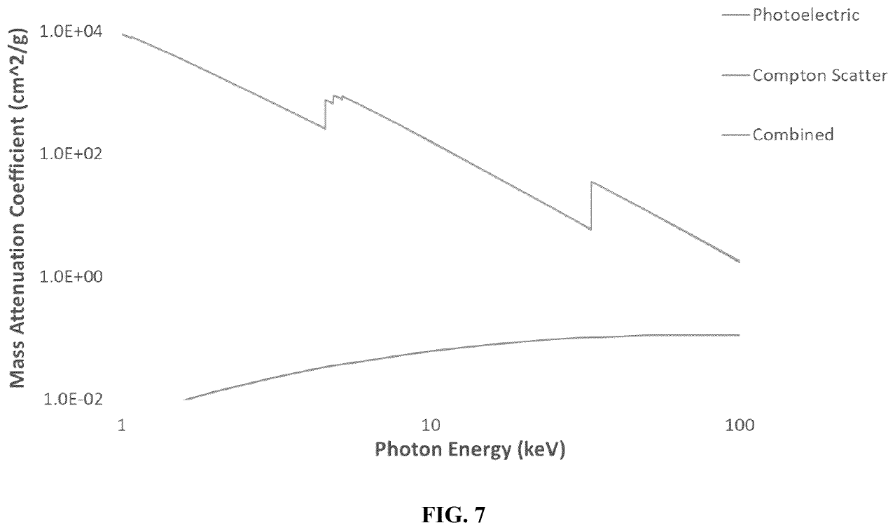

Before any embodiments are explained in detail, it is to be understood that the invention is not limited in its application to the details of construction and the arrangement of components set forth in the following description or illustrated in the following drawings. The invention is capable of other embodiments and of being practiced or of being carried out in various ways. The drawings referred to herein should not be understood as being drawn to scale unless specifically noted.

### DETAILED DESCRIPTION

Reference will now be made in detail to various embodiments of the subject matter, examples of which are illustrated in the accompanying drawings. While various embodiments are discussed herein, it will be understood that they are not intended to limit to these embodiments. On the contrary, the presented embodiments are intended to cover alternatives, modifications, and equivalents, which may be included in the spirit and scope of the various embodiments.

This disclosure presents advanced methods and systems for quantitative material characterization using multi-energy photon and neutron interactions. By extending traditional dual-energy techniques, the disclosed methods utilize multi-dimensional vector analysis derived from counts in multiple energy bins to enhance material differentiation. The approach leverages the distinct energy-dependent behaviors of the photoelectric effect (PE), Compton scattering (CS), pair production (PP), Rayleigh scattering, and various neutron interactions. By calculating differences, ratios, slopes, and particularly focusing on the angles and directions of these vectors across multiple energy channels and constructing two-dimensional (2D) and three-dimensional (3D) vectors, unique material signatures are obtained. These vector angles and their trajectories through specific quadrants correspond to specific materials, much like how the hands on a clock indicate time. This analogy underscores the precision with which the disclosed vectors describe the materials the photons have passed through.

Furthermore, the disclosed systems integrate neural networks trained on simulated data and incorporate a real-time feedback loop to correct for dark current, noise, and detector drift before vector analysis. This ensures that both Poisson noise and detector noise are eliminated, allowing the vectors to represent true material signals that match the trained simulation vectors. These enhancements further improve material discrimination capabilities in applications such as medical imaging, security screening, non-destructive testing, and material science.

### Definitions

Unless otherwise defined, all technical and scientific terms used herein have the same meaning as commonly understood by one of ordinary skill in the art. In case of conflict, the present document, including definitions, will control. Preferred methods and materials are described below, although methods and materials similar or equivalent to those described herein can be used in practice or testing of the present disclosure. All publications, patent applications, patents and other references mentioned herein are incorporated by reference in their entirety. The materials, methods, and examples disclosed herein are illustrative only and not intended to be limiting.

The terms “comprise(s),” “include(s),” “having,” “has,” “can,” “contain(s),” and variants thereof, as used herein, are intended to be open-ended transitional phrases, terms, or words that do not preclude the possibility of additional acts or structures. The singular forms “a,” “an” and “the” include plural references unless the context clearly dictates otherwise. The present disclosure also contemplates other embodiments “comprising,” “consisting of” and “consisting essentially of,” the embodiments or elements presented herein, whether explicitly set forth or not.

Reference throughout this specification to “one embodiment,” “certain embodiments,” “an embodiment,” “various embodiments,” “some embodiments,” or similar term(s) means that a particular feature, structure, or characteristic described in connection with the embodiment is included in at least one embodiment. Thus, the appearances of such phrases in various places throughout this specification are not necessarily all referring to the same embodiment. Furthermore, the particular features, structures, or characteristics of any embodiment may be combined in any suitable manner with one or more other features, structures, or characteristics of one or more other embodiments without limitation.

For the recitation of numeric ranges herein, each intervening number there between with the same degree of precision is explicitly contemplated. For example, for the range of 6-9, the numbers 7 and 8 are contemplated in addition to 6 and 9, and for the range 6.0-7.0, the number 6.0, 6.1, 6.2, 6.3, 6.4, 6.5, 6.6, 6.7, 6.8, 6.9, and 7.0 are explicitly contemplated.

The term “coupled,” as used herein, is defined as “connected,” although not necessarily directly, and not necessarily mechanically. The term coupled is to be understood to mean physically, magnetically, chemically, fluidly, electrically, or otherwise coupled, connected or linked and does not exclude the presence of intermediate elements between the coupled elements absent specific contrary language. In contrast, when an element is referred to as being “directly on,” “directly engaged to,” “directly connected to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.).

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another elements, component, region, layer, or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments. In the various embodiments, elements or any described steps do not imply any particular order of operation, unless explicitly stated therein.

“Attenuated electron counts” refer to the measurable electronic signal at the detector that results from X-ray or other photon-based radiation passing through one or more materials and interacting with the detector's sensor medium. When an X-ray beam is directed toward a subject, photons are absorbed or scattered by the materials in their path, reducing the number of photons that ultimately reach the detector. Those transmitted photons are detected and converted into an electronic signal—typically in the form of charge carriers (e.g., electrons or holes)—regardless of whether the detector architecture is based on photon-counting, energy-integrating, or other conversion principles. These signals are grouped or binned according to their corresponding photon energy ranges.

“Energy bins” refer to discrete energy ranges or windows used to categorize detected photons or electrons based on their energy levels, enabling spectral analysis of the detected radiation.

“Vector angles” and “material time signature” refer to the angular measurements between constructed vectors derived from differences in attenuated electron counts across energy bins, where these angles serve as material-specific signatures that correspond uniquely to different materials, analogous to how clock hands indicate a specific time.

“Multi-dimensional vectors” refer to mathematical constructs having two or more components derived from differences in photon or neutron interaction counts across multiple energy bins, where each vector component represents the difference between counts in paired energy channels within specific interaction regions. “Quadrant determination” refers to identifying which quadrant of a coordinate system a vector occupies based on the signs of its components.

“Real-time feedback loop” refers to a continuous monitoring and correction system that adjusts measurements for dark current, noise, and detector drift during data acquisition, ensuring accurate vector construction.

### Introduction

The present disclosure introduces a novel method and apparatus for quantitative imaging that exploits the distinct energy-dependent behaviors of the photoelectric effect (PE), Compton scattering (CS), and pair production (PP). By analyzing the ratios of PE to CS, PE to PP, and CS to PP at two or more energy channels, and constructing multi-dimensional vectors specifically two-dimensional (2D) and three-dimensional (3D) vectors, this disclosure provides a sensitive and robust metric for material characterization.

Different materials exhibit unique signatures in how their PE, CS, and PP contributions change across energy levels. These signatures can be captured by analyzing the slopes, angles, and directions of the PE, CS, and PP curves and the ratio of their differences (APE/ACS/APP) between energy channels. This multi-dimensional analysis enables more accurate and reliable differentiation of similar-density materials.

This method can be extended to any photon wavelength where interaction probabilities are known, including visible photon imaging techniques such as Raman spectroscopy, infrared imaging, and gamma spectroscopy for homeland security applications.

### Angular Vector-Based Inference Framework

Conventional photon-counting CT systems perform material discrimination by segmenting the X-ray spectrum into discrete energy bins and solving for attenuation coefficients, μ(E), across those bins. These values are then used in material decomposition algorithms, often requiring projection-based reconstructions or spectral basis fitting to isolate tissue types. In contrast, the present disclosure introduces a novel representational framework called angular vector-based inference.

Rather than treating each energy bin as a scalar input for curve fitting, the method forms two directional vectors per pixel. One vector is constructed from energy bins in the photoelectric-dominant (PE) region, and the other from bins in the Compton scatter (CS) region. The angles between these vectors capture the relational dominance of PE versus CS interactions, which is highly sensitive to a material's (e.g., a tissue's) effective atomic number (Zeff) and density. This angular relationship, referred to as the “material time” signature, serves as a unique identifier of material (e.g., tissue) composition.

Because the method operates on directional relationships rather than scalar attenuation values, it bypasses the need for material decomposition entirely. No sinogram reconstruction, spectral basis solving, or grayscale projections are required. Instead, the angular data is input directly into a physics-informed neural network (PINN) trained to recognize material-specific (e.g., tissue-specific) vector geometries. This enables real-time, low-power, explainable inference, making the technique highly suitable for edge computing environments and compact diagnostic platforms.

### Acquisition of Attenuated Electron Counts

When an X-ray beam is directed toward a subject, photons are absorbed or scattered by the materials in their path, reducing the number of photons that ultimately reach the detector. Those transmitted photons are detected and converted into an electronic signal, typically in the form of charge carriers such as electrons or holes, regardless of whether the detector architecture is based on photon-counting, energy-integrating, or other conversion principles. These signals are grouped or binned according to their corresponding photon energy ranges.

For each detector pixel, the attenuated electron count within a specific energy bin represents the net quantity of charge generated by photons detected in that range after attenuation by the material. These values serve as the input for constructing photoelectric (PE) and Compton scatter (CS) vectors.

### Calibration Methods for Accurate Attenuation Determination

To accurately determine attenuation, the system may employ one or more reference calibration methods. The Reference Pixel Method uses one or more designated reference pixels, either on the edge of the imaging field or within a known low-attenuation region, to receive the unattenuated X-ray spectrum. These are identified dynamically as the brightest pixels in terms of raw detector electron counts, not post-processed image display, or through fixed system geometry. The signal in each energy bin from these reference pixels is used as a live intra-scan baseline, and subtracted from the measured signal at other pixels to determine material-specific attenuation.

The Pre-Scan Calibration Method stores a pre-calibrated reference spectrum, which represents the expected detector response in electron counts or charge across all energy bins in the absence of any intervening material. This reference may be measured once during system manufacturing, at regular intervals such as daily or weekly, prior to each imaging session, or dynamically through a short calibration scan before the main acquisition. This reference may be derived using air scans, beam-profile characterization, or flat-field correction techniques, and is stored in system memory for subtraction during analysis.

Hybrid or Adaptive Calibration combines reference pixel detection and pre-stored calibration data to refine the subtraction process. This may include compensation for detector drift, system aging, or non-uniform pixel response, and allows for adaptive recalibration during or between scans. This flexible calibration framework ensures that attenuated electron counts are always referenced to a known baseline, allowing robust vector construction across hardware types, detector architectures, scan conditions, and imaging domains.

### Compatibility with Energy-Integrating and Photon-Counting Architectures

The disclosed angular vector signal processing method is compatible with both energy-integrating detectors and digital pulse processing (photon-counting) detectors. In both cases, the method forms vectors using paired energy bins, one in the photoelectric-dominated region and one in the Compton scatter-dominated region. The vectors are constructed from differences in detected electron counts or photon event counts across each bin pair, and the angle between the PE and CS vectors serves as a material-specific signature.

In photon-counting systems, these vectors are derived from discrete event counts captured in narrowly defined energy windows, providing precise spectral resolution. In energy-integrating systems, the vectors are formed from analog-integrated electron signals, although digital methods can also be used to create vectors, which reflect the same photon interactions with materials but with reduced complexity and improved low-dose performance.

The vector method operates identically in both modes by analyzing the angular relationship between bins, not their absolute values. As a result, the method remains robust across detector types, dose levels, and noise environments, enabling accurate tissue differentiation without relying on full spectral decomposition or image reconstruction.

### Two-Dimensional Vector Analysis

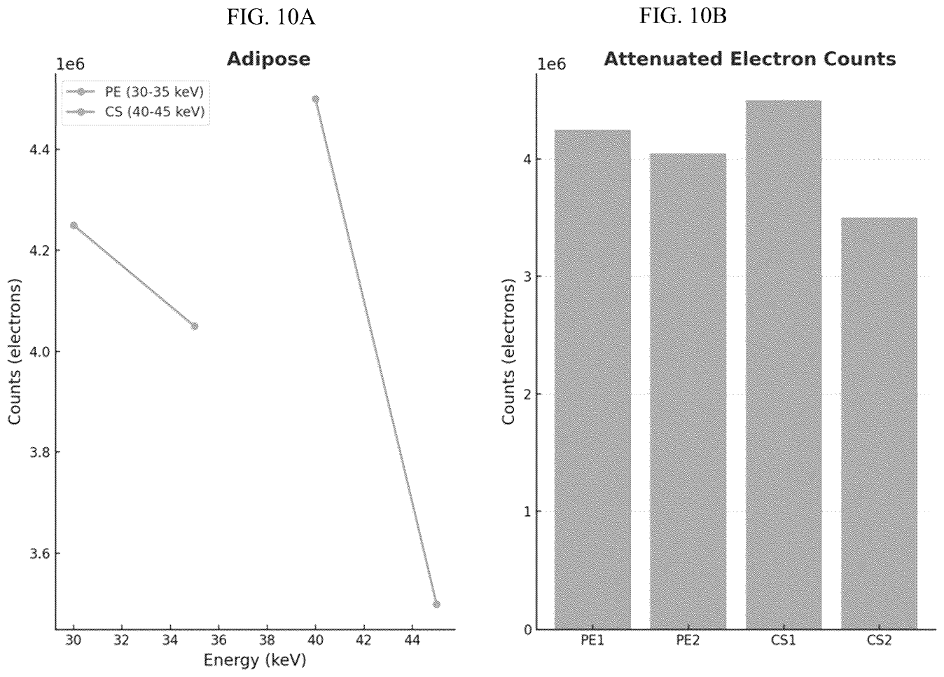

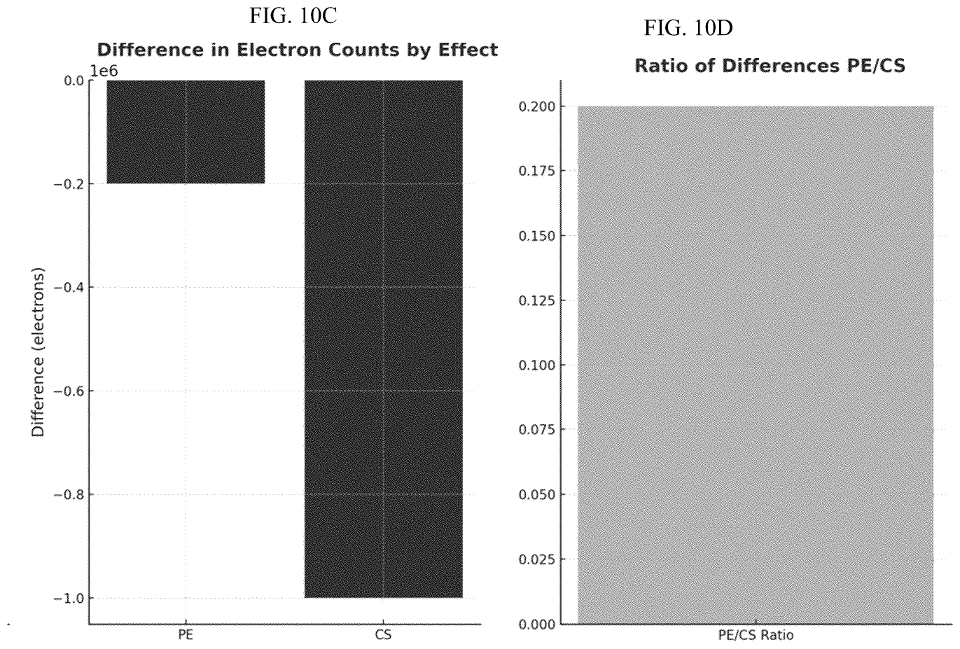

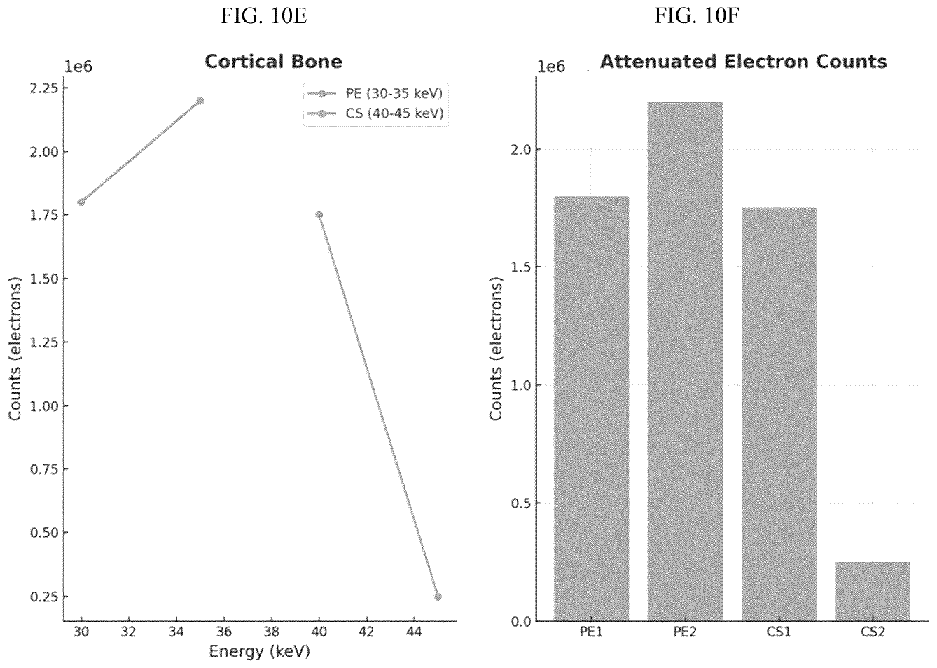

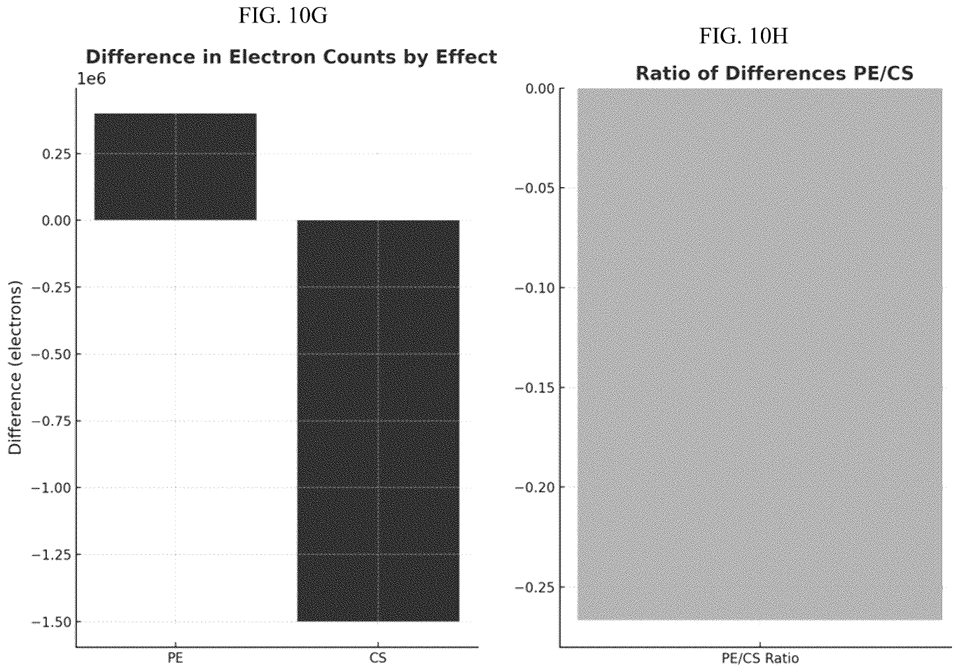

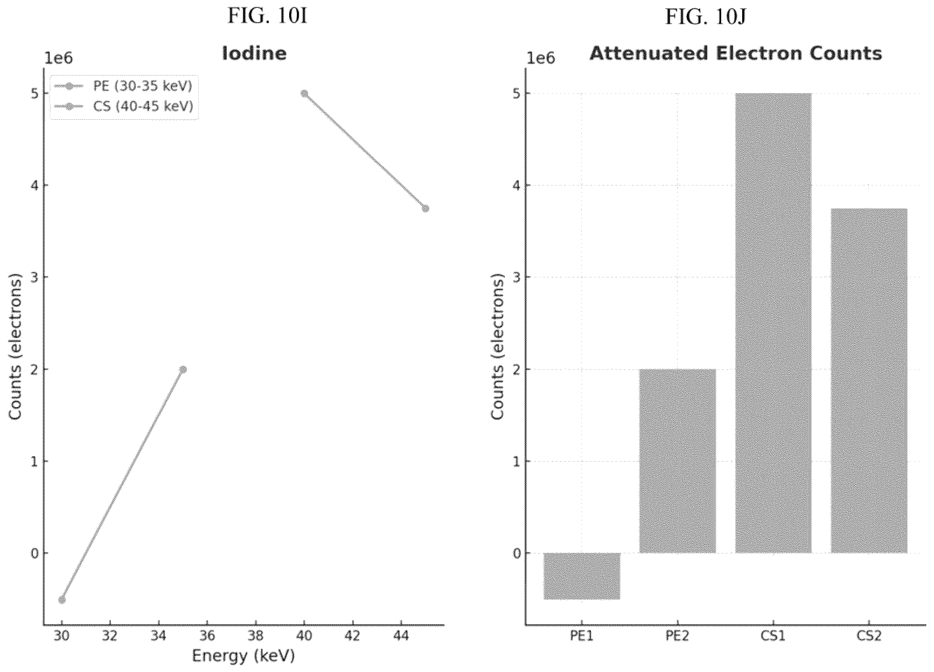

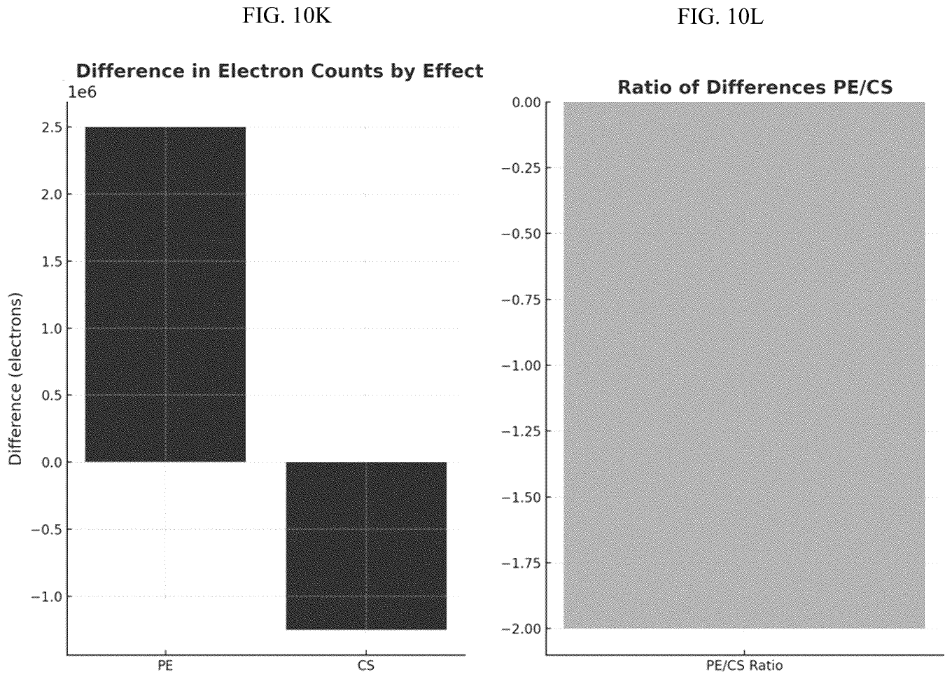

The construction of 2D vectors follows a systematic approach as illustrated in FIG. 10. Energy Bin Selection for 2D Vector involves selecting two energy bins within the PE dominant region, designated as Bin 1 (E₁) and Bin 2 (E₂), and two energy bins within the CS dominant region, designated as Bin 3 (E₃) and Bin 4 (E₄).

Data extraction and real-time noise correction extracts the counts for each selected energy bin from the detection data, applies real-time feedback loop to correct for dark current, noise, and detector drift, and ensures that the corrected counts represent true material signals.

The system calculates differences where the PE Difference is computed as APE=CountsBin2−CountsBin1 and the CS Difference is computed as ΔCS1=CountsBin4−CountsBin3. The 2D vectors are then constructed as v_{2D}=(ΔPE, ΔCS1).

The system computes several important metrics from these vectors. The Effective Ratio between PE and CS1 is calculated as ΔPE divided by ΔCS1. The Magnitude or Hypotenuse is determined using the Pythagorean theorem as H_{2D}=√[(ΔPE)²+(ΔCS1)²]. The Angle θ with respect to the CS axis is computed using the arctangent function where θ=arctan (ΔPE/ΔCS1). Additionally, the Direction and Quadrant Information is determined by the signs of ΔPE and ΔCS1, which indicate the quadrant in which the vector resides.

### Practical Examples of 2D Vector Analysis

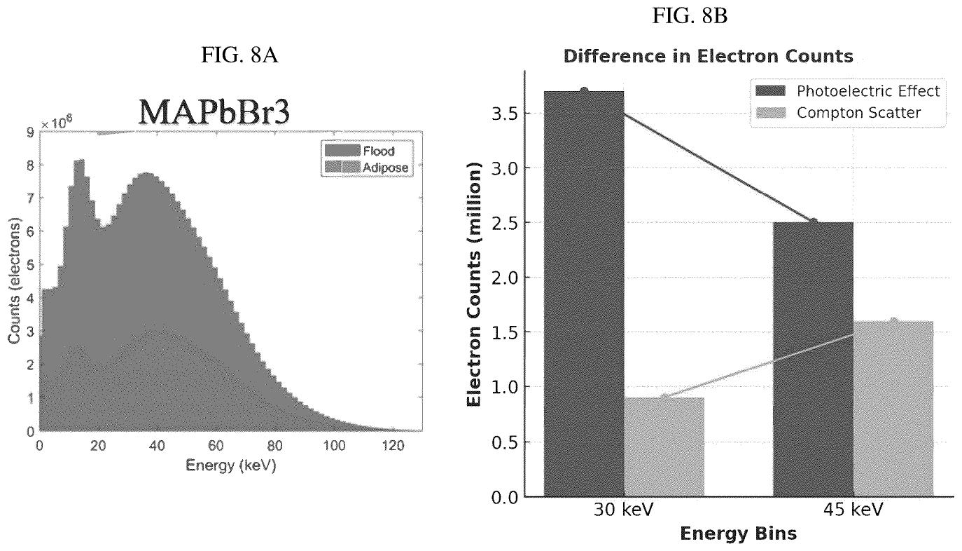

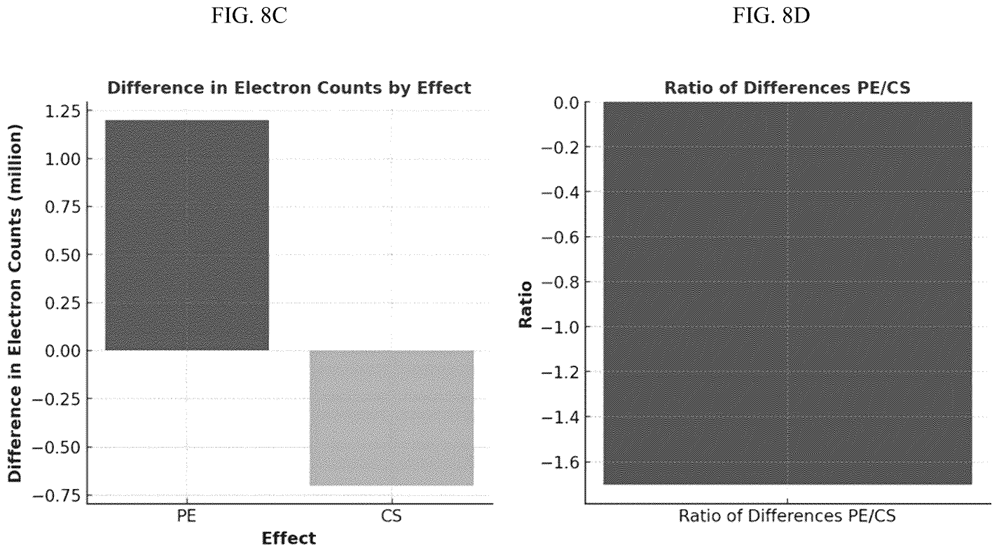

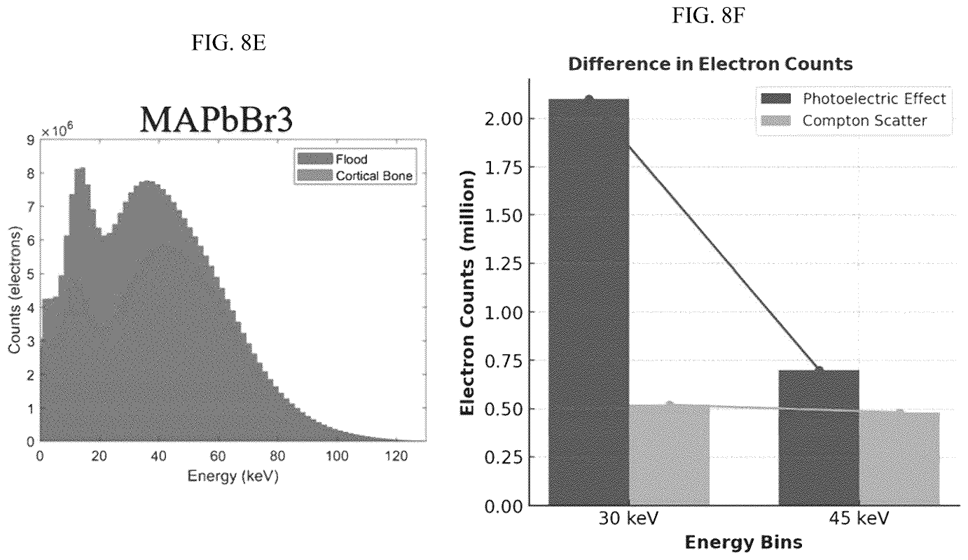

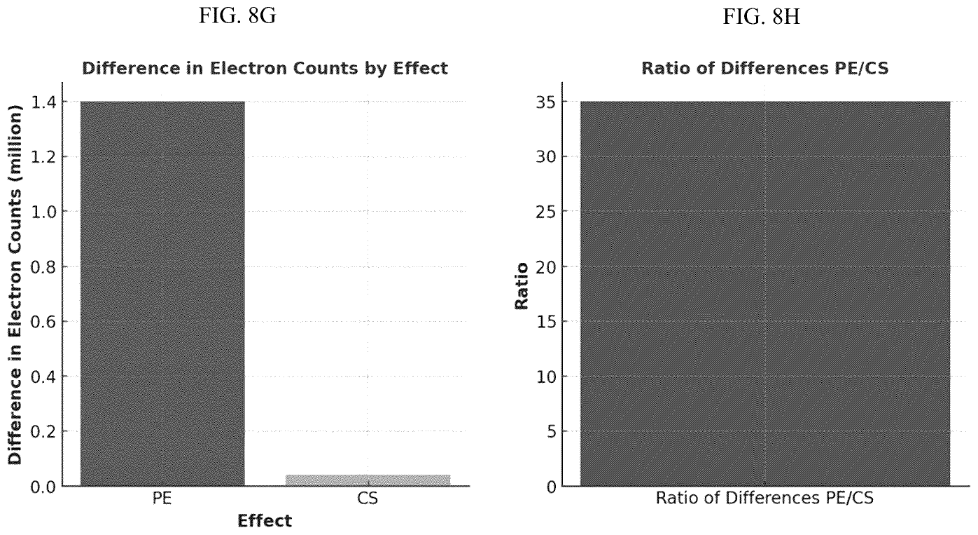

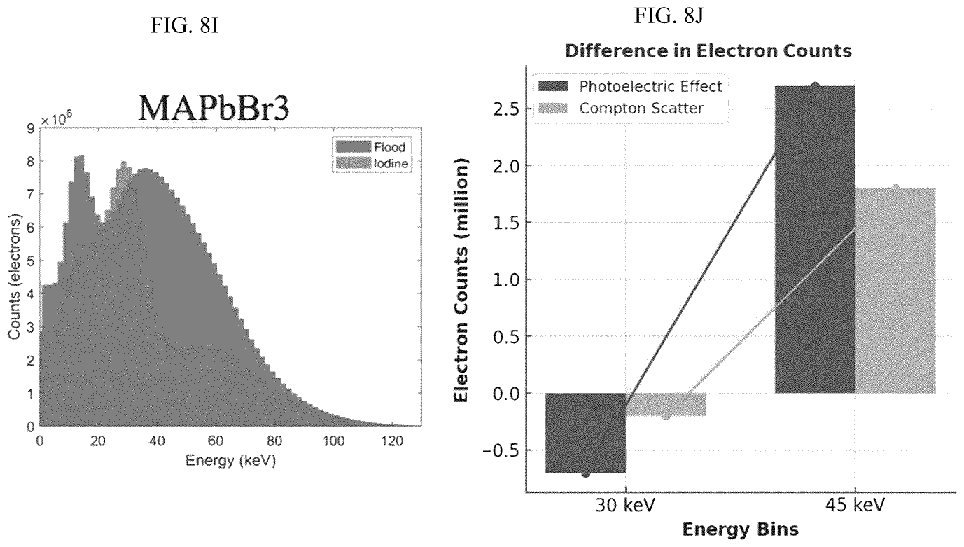

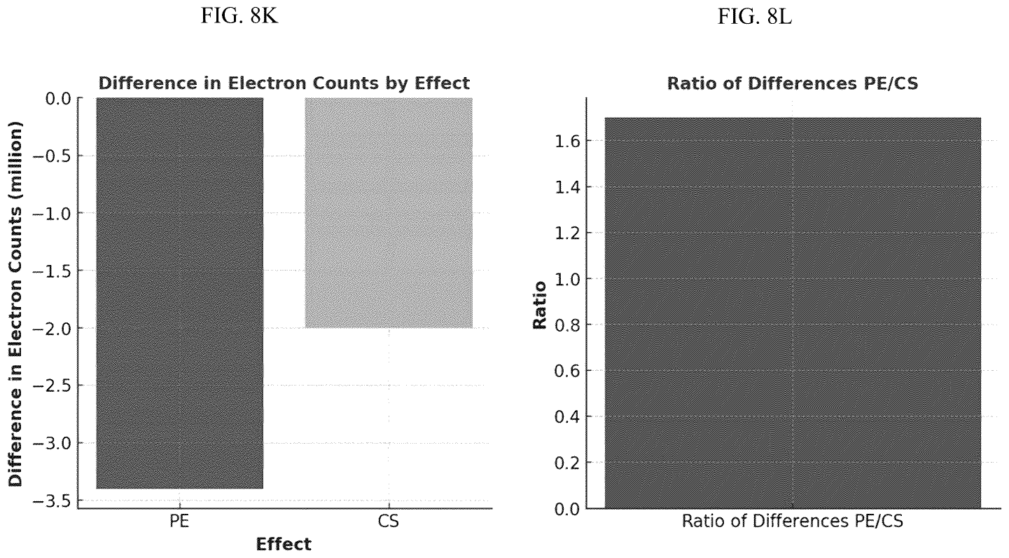

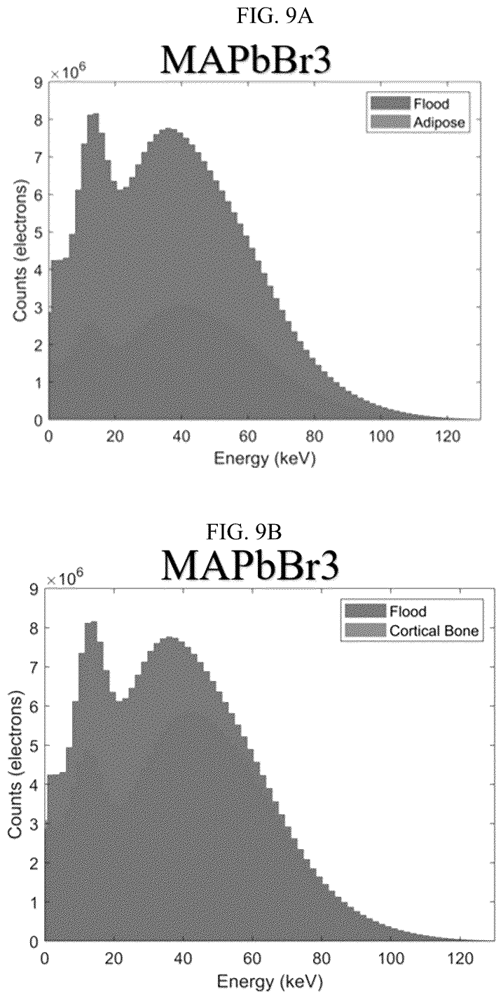

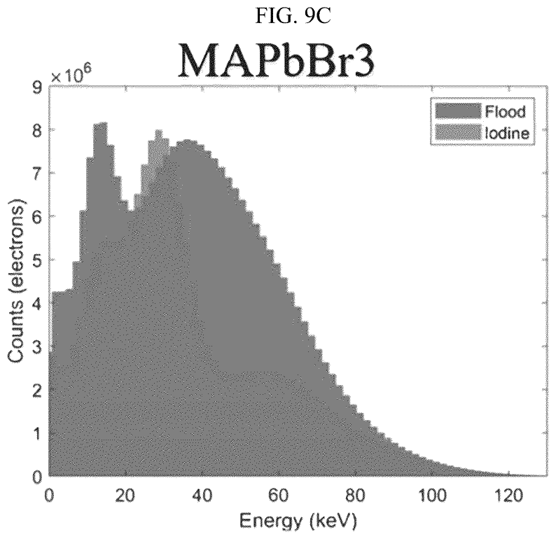

Example for Adipose Tissue: Using data from FIGS. 8 and 10, the analysis for adipose tissue proceeds as follows. The counts from energy data show that in the PE Region (30-35 keV), the counts at 30 keV equal 4,250,000 and the counts at 35 keV equal 4,050,000. In the CS Region (40-45 keV), the counts at 40 keV equal 4,500,000 and the counts at 45 keV equal 3,500,000.

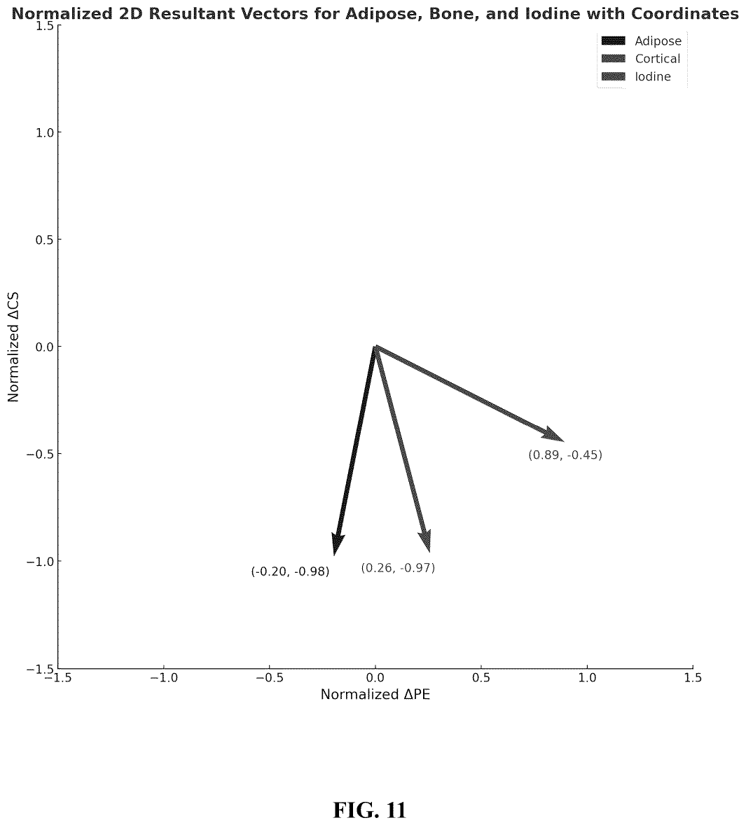

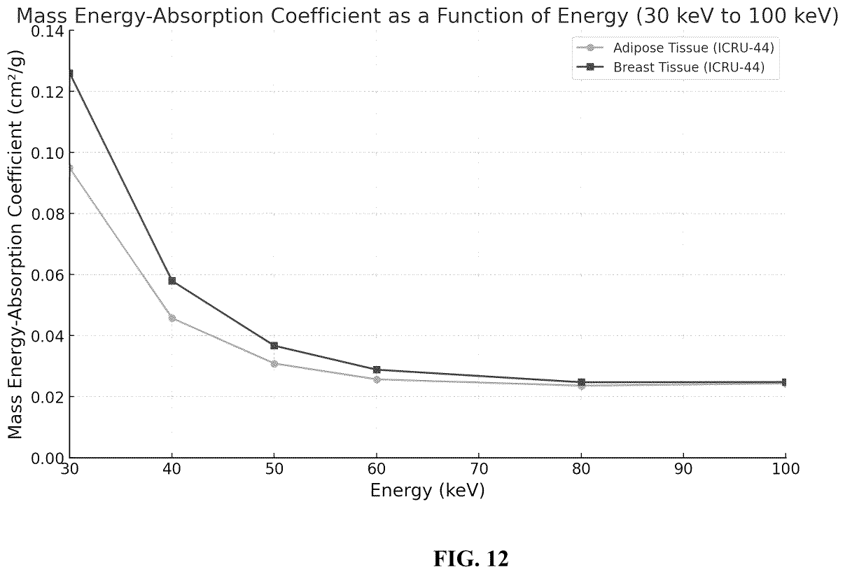

The calculated differences show ΔPE=4,050,000−4,250,000=−200,000 and ΔCS1=3,500,000−4,500,000=−1,000,000. The Effective Ratio (PE/CS1) is computed as −200,000 divided by −1,000,000, which equals 0.2. The Magnitude of Hypotenuse Resultant Vector, as shown in FIG. 11, is calculated as H_{2D}=√[(−200,000)²+(−1,000,000)²]≈1,019,804.78. The Angle θ is calculated as θ=arctan (−200,000/−1,000,000)=168.69°. For Quadrant Determination, as shown in FIG. 10, the ΔPE vector is in Quadrant II and ΔCS1 vector is in Quadrant IV.

Example for Cortical Bone: The analysis for cortical bone shows that in the PE Region (30-35 keV), the counts at 30 keV equal 1,800,000 and the counts at 35 keV equal 2,200,000. In the CS Region (40-45 keV), the counts at 40 keV equal 1,750,000 and the counts at 45 keV equal 250,000.

The calculated differences are ΔPE=2,200,000−1,800,000=400,000 and ΔCS1=250,000−1,750,000=−1,500,000. The Effective Ratio (PE/CS1) equals 400,000 divided by 1,500,000, which is approximately −0.27. The Magnitude is calculated as H_{2D}=√[(400,000)²+(−1,500,000)²]=1,552,410.77. The Angle θ equals arctan (400,000/−1,500,000)=165.22°. For Quadrant Determination, the ΔPE vector is in Quadrant III and is above the ΔCS vector, while the ΔCS1 vector is in Quadrant IV.

Example for Iodine Contrast: The iodine contrast analysis shows that in the PE Region (30-35 keV), the counts at 30 keV equal-500,000 and the counts at 35 keV equal 2,000,000. In the CS Region (40-45 keV), the counts at 40 ke V equal 5,000,000 and the counts at 45 keV equal 3,750,000.

The calculated differences are ΔPE=2,000,000−(−500,000)=2,500,000 and ΔCS1=3,750,000−5,000,000=−1,250,000. The Effective Ratio (PE/CS1) equals 2,500,000 divided by −1,250,000, which equals −2.0. The Magnitude is calculated as H_{2D}=√[(2,500,000)²+(−1,250,000)²]=2,795,084.71. The Angle θ equals arctan (2,500,000/−1,250,000)=116.57°. For Quadrant Determination, the ΔPE vector is in Quadrant III and is below the ΔCS vector, while the ΔCS1 vector is in Quadrant IV.

### Material-Specific Vector Signatures and Clock Analogy

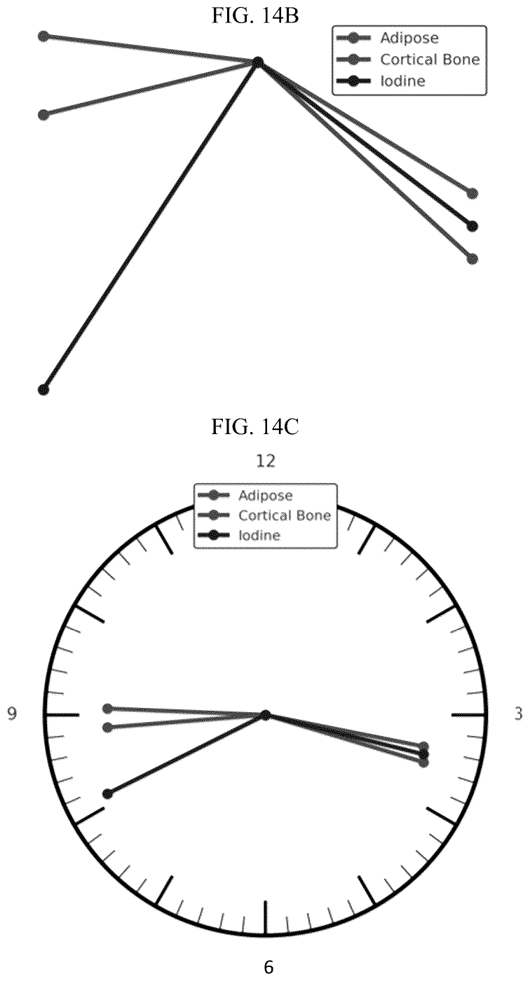

As demonstrated in FIG. 14, the comparison of attenuated electron counts for three materials (Adipose, Cortical Bone, and Iodine) across two energy segments (30-35 keV and 40-45 keV) reveals distinct vector patterns. Monte Carlo simulations were performed using GATE (a Geant4-based platform) with the PENELOPE physics package to accurately model radiation transport and interactions. The vectors are shifted so that the endpoints at 35 keV and 40 keV intersect at a (0,0) point of origin, emphasizing angular differences between the materials. The shifted vectors are scaled to fit a circular “clock” representation, preserving slopes and angular relationships for intuitive visual comparison.

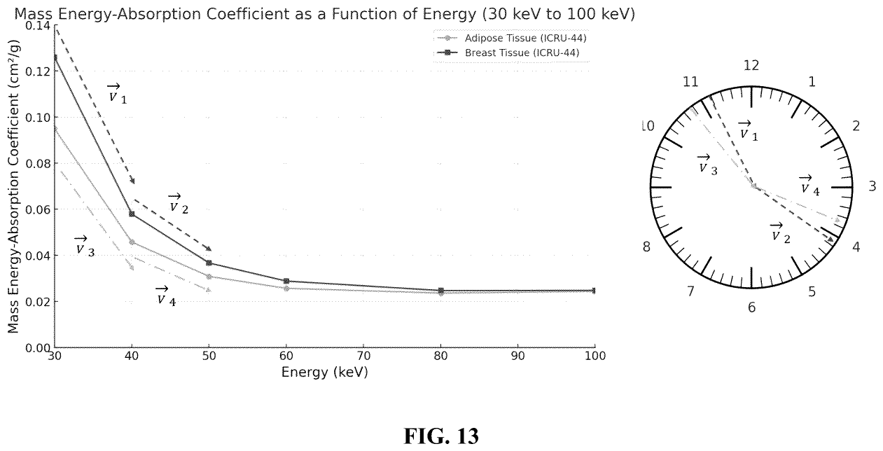

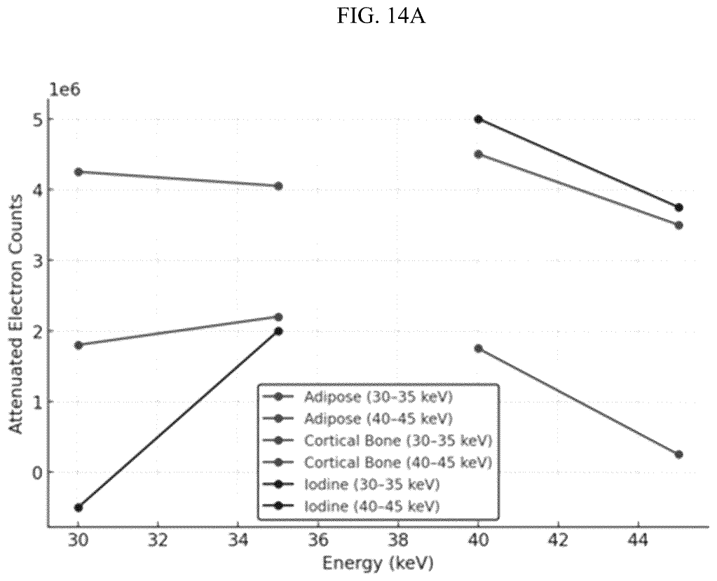

The calculated angles provide a unique signature for each material, as shown in FIG. 13. Using the clock analogy, Adipose Tissue corresponds to 10:25 o'clock, Cortical Bone corresponds to 8:20 o'clock, and Iodine Contrast corresponds to 4:35 o'clock. The theta angles for the PE and CS vectors can be derived from these pseudo clock times, like the big and little hands on a clock, and serve as distinguishing features to identify materials.

Material-Specific Vector Angles and Directions, as illustrated in FIG. 13, show that the angle θ and the quadrant through which the vector moves correspond uniquely to each material, much like the hands on a clock indicate a specific time. These angles and directions reflect the specific mass attenuation curves of materials, allowing for precise differentiation.

### Three-Dimensional Vector Analysis and Higher-Dimensional Extensions

Three-Dimensional (3D) Vector Analysis extends the concept by incorporating additional energy bins from higher energy CS regions or PP regions. An additional difference is calculated as ΔCS2 or ΔPP, and 3D vectors are constructed as v_{3D}=(ΔPE, ΔCS1, ΔCS2) or v_{3D}=(ΔPE, ΔCS1, ΔPP). Additional Effective Ratios are computed such as the CS1/CS2 ratio calculated as ΔCS1 divided by ΔCS2. The 3D Magnitude is determined as H_{3D}=√[(ΔPE)²+(ΔCS1)²+(ΔCS2)²]. Angles between vector components provide more detailed material signatures, and the vectors' trajectories through specific quadrants in three-dimensional space further enhance material differentiation.

Extending the analysis to three or more dimensions by incorporating additional energy bins can further refine material differentiation, capturing more complex interactions and subtle differences. The methods demonstrate scalability by being extendable to higher dimensions for increased accuracy.

### Enhanced Material Identification Using Multiple Angular Vector Pairs

To further increase the specificity of material identification, the system may utilize multiple independent angular vector pairs, each derived from distinct energy bin sets. In one embodiment, a first pair of vectors is computed from photon count differences across two bins in the photoelectric-dominated region and two bins in the Compton-dominated region (for example, 22-28 keV vs 28-35 keV, and 65-75 keV vs 75-85 keV). A second, independent angular pair is constructed from a different set of energy bins (for example, 35-40 keV vs 40-45 keV and 85-95 keV vs 95-110 keV). The system then uses the combination of these two angular signatures as a multi-dimensional constraint, significantly reducing the likelihood that different materials or tissue combinations produce indistinguishable vector geometries.

This approach is analogous to keyspace narrowing in cryptographic systems, wherein each additional constraint exponentially reduces the solution space. The neural network classifier such as a PINN may be trained on the joint distribution of these angular pairs, enabling it to resolve tissue identities or material compositions that would otherwise appear confounded under a single angular analysis. This technique improves robustness to mixed-path attenuation, tissue overlap, and noise, and further enhances classification accuracy in both 2D projection space and 3D tomographic configurations.

### Vector Signature Fidelity Across Dimensional Imaging and Tissue Complexity

To ensure accurate material identification across imaging modalities, the angular vector signal processing method is designed to function in static 2D radiography, quasi-3D tomosynthesis, and fully 3D CT acquisition systems. The underlying physics relies on extracting the angular relationship between photoelectric (PE) and Compton scatter (CS) vectors, which are derived from paired energy bins and reflect the dominant interaction processes of X-ray photons with matter.

The system may be trained on both first-principles vector signatures generated by mono-material paths (that is, single tissue types or pure substances), and on layered, path-integrated signatures that reflect realistic clinical geometries, where multiple tissue types contribute to the final attenuation signal. These mixed-path vector geometries often produce “blurred” or nonlinear shifts in PE-CS angular relationships due to the cumulative effect of spatially heterogeneous materials.

By simulating both idealized and anatomically representative training data (for example, via Monte Carlo methods such as GEANT or GATE), the system's neural network learns to recognize angular distortions that arise from specific material combinations and their relative positions. This enables the model to infer dominant or target materials even in overlapping, low-contrast, or obliquely layered configurations common in radiographic and tomographic acquisitions.

As a result, the method achieves robust tissue differentiation not only in isolated voxels, but also in projection-space and volumetric contexts, enabling its use across a wide range of imaging architectures without requiring full material decomposition or back-projection reconstruction. Furthermore, the system is robust to scattering artifacts, such as Compton scattering, which introduce noise across energy bins. Because the method relies on relative vector orientation rather than absolute count values, angular signatures remain interpretable even in the presence of scatter-induced signal contamination.

### Ratios of Differences and Mathematical Framework

One aspect of the disclosure relates to calculating the ratios of differences between the PE, CS, and PP across the selected energy channels. The PE to CS ratio is defined as R(PE/CS)=(ΔPE(E1)−ΔPE(E2))/(ΔCS(E1)−ΔCS(E2)), where ΔPE(E1) and ΔPE(E2) are the photoelectric effects at energy channels E1 and E2, respectively, and ΔCS(E1) and ΔCS(E2) are the Compton scatter effects at the same energy channels.

Similarly, the PE to PP ratio is expressed as R(PE/PP)=(ΔPE(E1)−ΔPE(E2))/(ΔPP(E1)−ΔPP(E2)), and the CS to PP ratio is R(CS/PP)=(ΔCS(E1)−ΔCS(E2))/(ΔPP(E1)−ΔPP(E2)), where ΔPP(E1) and ΔPP(E2) are the pair production effects at the respective energy channels.

The calculated ratios R(PE/CS), R(PE/PP), and R(CS/PP) provide unique identifiers for the material, which can be used to distinguish between similar-density soft tissues. Any mathematical expression can be used to create a difference in vector angles between two or more interaction mechanisms across two or more energy channels. This flexibility allows for a wide range of mathematical approaches, including derivatives, differentiations, and other mathematical operations, to calculate the vector angles and ratio-metric values.

### Slope Analysis

The slopes of the lines representing the PE, CS, and PP interactions at different energy channels are analyzed to enhance material identification capabilities. These slopes, combined with the ratios of differences, enhance the ability to identify and quantify materials. The slope of PE with respect to CS is defined as S(PE/CS)=d(PE)/d(CS). The slope of PE with respect to PP is S(PE/PP)=d(PE)/d(PP). The slope of CS with respect to PP is S(CS/PP)=d(CS)/d(PP).

### Photon Counting with Multi-Spectral Energy Integration and Real-Time Noise Correction

Traditional photon counting methods face limitations due to Poisson statistical fluctuations caused by random photon arrival times. Detector noise, such as dark current and drift, can further degrade signal quality, and small statistical variations can affect the stability of material differentiation.

The technology described herein addresses these limitations through Energy Integration and Real-Time Feedback Loop mechanisms. The system integrates the total energy deposited by photons within each energy channel and implements a real-time feedback loop where dark current, noise, and detector drift data from the imaging unit detector are input into the AI neural network before vector analysis. This approach eliminates both Poisson noise and detector noise from the measurements and ensures that vectors represent true material signals that match the trained simulation vectors.

The enabling technology employs ASICs or TFT backplanes with Multi-Channel Analyzers (MCAs) and Field-Programmable Gate Arrays (FPGAs). This approach allows for efficient collection and integration of a large number of electrons per photon with minimal k-fluorescence spectral corruption.

The calculated vectors and angles are derived from noise-corrected counts, ensuring that statistical fluctuations and detector artifacts do not affect material identification. This alignment between measured data and simulation enhances the accuracy of the method.

### Advanced Signal Processing Features

To enhance performance, robustness, and deployment flexibility, the system incorporates several advanced signal processing and control features. Analog Dynamic Energy Binning, inspired by biological systems such as the dodder vine, includes an analog front-end design in which the integrated charge is dynamically split into multiple energy bins before digitization. This allows bin discrimination to occur in real time, without requiring a multichannel analyzer (MCA) or full energy digitization. The result is a compact, low-power, low-noise analog pathway that produces well-defined spectral bins suitable for angular vector construction.

AI-Driven Adaptive Binning Control employs a machine learning subsystem to dynamically adjust bin thresholds such as comparator voltages based on real-time spectral input. This feedback loop enables optimal placement of PE and CS bin boundaries depending on the detected tissue environment, patient-specific variability, or target contrast agents. By refining bin configurations during acquisition, the system maximizes spectral separability and improves diagnostic specificity.

Spherical Vector Normalization processes PE and CS vectors by normalizing them to unit magnitude and projecting them onto a unit hypersphere prior to classification. This preserves angular relationships key to material identification while eliminating dependence on total photon flux or exposure path length. The approach ensures that classification relies solely on the intrinsic spectral shape, rather than on confounding variables such as tissue thickness, scan dose, or detector saturation.

Wave-Based Interference Processing represents an algorithmic signal-processing technique in which spectral vectors are analyzed for constructive or destructive alignment patterns in their angular relationships. In some configurations, spectral vectors may be processed using interference-based methods that treat each vector component as a waveform. The system performs constructive or destructive interference analysis to amplify subtle angular distinctions between adjacent tissue types or materials with similar Z-effective values. This wave-domain enhancement provides an additional layer of contrast beyond simple geometric angular comparison. It should be noted that this refers to computational signal processing and does not refer to physical wavefront interference techniques used in optical or phase-contrast imaging systems, such as Talbot-Lau grating interferometry or diffraction-based methods.

Tensor-Based Multidimensional Representation allows the system to model the acquired data as a high-dimensional tensor spanning spatial (X, Y), spectral (energy bin), and temporal domains. This enables the use of advanced neural network architectures including convolutional neural networks (CNNs) and tensor decomposition frameworks that extract correlated features across both space and spectral shape. Such architectures can further enhance material separation and localization, especially in tomosynthesis and CT configurations.

### Neural Networks Trained with Simulated Data

The system integrates advanced computational methods by utilizing neural networks trained on simulated data from platforms such as GEANT4 simulations for various tissues and materials, using a specific sensor detector material. Simulations provide the AI with expected sets of vector angles and quadrant information corresponding to each material, and the neural network learns the relationships between the simulated detector responses and the material properties.

The Architecture Design includes an Input Layer with multidimensional representation of counts from various energy bins, corrected for noise and drift. Hidden Layers capture complex patterns and relationships between interaction types. The Output Layer classifies tissues or materials based on processed input vectors.

Real-Time Noise Correction and Data Alignment ensures that the real-time feedback loop adjusts for dark current, noise, and detector drift before vector construction. This ensures that measured vectors align with the simulated vectors used in training, leading to improved material discrimination where neural networks enhance robustness and handle complexities in material differentiation while amplifying subtle differences in vector angles and directions corresponding to material-specific attenuation characteristics.

The integration of AI algorithms to recognize these unique identifiers and combine them with the “Ratio of Differences” and slope analysis to accurately identify materials is a promising enhancement. AI can amplify subtle differences, making the method more robust and reliable. AI and machine learning models can be trained on the unique electronic signatures created by the interplay between the slopes of the lines for PE, CS, and PP across different energy channels. This training can lead to the development of sophisticated algorithms capable of high-precision material differentiation.

### Vector Angles and Electronic Structure

The method leverages the unique set of vector angles formed by the probabilities of interaction of photons or neutrons with a material at two or more different energy channels. Each interaction mechanism such as photoelectric effect, Compton scattering, and pair production has a distinct probability curve as a function of energy. When photons or neutrons pass through a material, the probabilities of these interactions vary based on the material's electronic structure, including its atomic number (Z) or effective atomic number (Z-effective).

By measuring the probabilities of different interaction mechanisms at multiple energy levels, unique vector angles can be calculated. These vector angles represent the relative contributions of each interaction mechanism at different energies. The combination of these vector angles is specific to the material's electronic structure, providing a unique identifier for the material.

Photons that pass through tissue carry the atomic number information of that tissue due to the specific probabilities of interaction mechanisms such as Compton scattering (CS) and the photoelectric effect (PE). As photons travel through different materials, their interaction probabilities change according to the material's electronic structure. The counts that make it to the detector are influenced by these probabilities, which are specific to each material and different tissues.

When measured at two or more energy channels, the interaction probabilities of CS and PE allow the photons to carry the unique electronic structure information of the material they have passed through. This means that the detector, by analyzing the interaction probabilities at different energy levels, can derive quantitative information about the material's atomic number or Z-effective. Essentially, the photons serve as carriers of material-specific interaction data, providing detailed insights into the electronic structure of the tissues or materials they encounter.

### Extension to Neutron Interactions

The principles of material differentiation through ratio-metric analysis can be extended to neutron interactions, providing a novel approach for quantitative material characterization. Similar to the dual-slope technique employed for photons, neutron interactions such as elastic and inelastic scattering exhibit distinct energy-dependent behaviors.

By irradiating a target with neutrons at multiple energy levels and detecting the scattered neutrons using a suitable detector such as a scintillator coupled with a photomultiplier tube or a solid-state neutron detector, the resulting neutron counts can be analyzed to extract valuable information about the material's composition and structure. The technology leverages the fact that different materials exhibit unique signatures in how their elastic and inelastic scattering contributions change across energy levels. These signatures can be captured by analyzing the slopes of the elastic and inelastic scattering curves, and the ratio of their differences (Δelastic/Δinelastic) between energy bins.

For example, in some embodiments, a material is characterized by the angle formed between the slope of the elastic scattering curve and the slope of the inelastic scattering curve in a plot of neutron counts versus energy. This angle, along with other derived metrics like the ratio of differences, can serve as a quantitative fingerprint for the material, enabling its identification and differentiation from other materials.

The extension of this method to neutron interactions opens up new possibilities for material characterization in fields such as Nuclear Physics for investigating nuclear properties and structure of materials, Materials Science for characterizing and differentiating materials based on their neutron scattering properties, potentially leading to the development of new materials with tailored properties, and Non-Destructive Testing (NDT) for analyzing the internal structure and composition of materials without causing damage, which is crucial in industries like aerospace, automotive, and construction.

### Composition Camera Interface for Material-Specific Imaging

The system includes a display system for visualizing material composition that comprises a processing module configured to receive input data comprising vector-based material identity information derived from photon interaction ratios across energy bins or spectral channels. A composition visualization module is configured to generate a two-dimensional or three-dimensional image wherein spatial locations are coded based on identified material type. This enables generating a material composition image utilizing the vector method as the input with spatially coded identity labels in the form of a heat map, and optionally overlaying that image onto a conventional anatomical or grayscale image.

An optional interface layer allows said composition image to be displayed independently or superimposed onto a conventional grayscale or anatomical image, wherein the system supports input across a plurality of photon wavelength domains, including ionizing and non-ionizing spectra.

### Applications

The method allows for precise tissue characterization in Medical Imaging, aiding in early disease detection and improved diagnostic accuracy by distinguishing tissues with similar densities but different compositions. The potential to quantify differences between cancerous and non-cancerous tissues by using these unique identifiers is a critical application in Cancer Detection. This method could significantly enhance the early detection and treatment of cancer, improving patient outcomes.

Enhanced detection of hazardous materials and special nuclear materials (SNMs) is possible in Security Screening by analyzing unique vector signatures, reducing false positives and improving security measures. This X-ray method can be used to detect Special Nuclear Materials (SNM) in combination with neutron imaging. If the SNM is shielded, neutrons can penetrate the shielding (high Z material) to identify the material behind the shield, imaging low Z materials. If the SNM is not shielded, the vector angles and ratio-metric values from X-rays can be used as discussed, with neutrons identifying and imaging lower Z-effective values.

Material Science benefits from Non-destructive testing through this method by identifying material flaws and compositions through detailed interaction analysis. Beyond medical imaging, this technology holds potential for broader applications in material science and security screening.

The methodology's ability to extend to any photon wavelength where interaction probabilities are known, such as PE and Rayleigh scattering in visible photons, enhances its utility across a wide range of imaging applications, including Raman spectroscopy. For visible photons, the ratios and slopes can be defined similarly where R(PE/Rayleigh)=(ΔPE(E1)−ΔPE(E2))/(ΔRayleigh(E1)−ΔRayleigh(E2)) and S(PE/Rayleigh)=d(PE)/d(Rayleigh).

### Cross-Modality Applicability

Although described primarily in the context of X-ray imaging, the angular vector signal processing method is equally applicable to gamma spectroscopy, neutron imaging, and other energy-dependent particle detection systems. In such embodiments, detected photon energies are binned according to their dominant interaction mechanisms or energy loss features, and angular relationships between bin vectors are computed to infer material identity, shielding characteristics, or radiotracer composition. This approach may also extend to applications in nuclear medicine such as SPECT, environmental radiation monitoring, and gamma-based industrial inspection.

While the system is described primarily in the context of radiological imaging, the same vector angle processing method may be applied to security screening, industrial non-destructive testing, radiation dosimetry, and space-based spectral detection, where identifying material composition or Z-effective transitions is critical. The method's ability to operate without full image reconstruction and its compatibility with compact, low-power hardware makes it especially well-suited for portable, autonomous, or mission-critical environments.

### Advantages

The disclosure provides Enhanced Material Differentiation through unique vector angles and directions that provide precise material signatures. Robustness to Noise is achieved through real-time noise correction that ensures accurate measurements. The approach demonstrates Versatility by being applicable across various imaging modalities and materials.

AI Integration enhances detection capabilities based on vector analysis using neural networks. Comprehensive Analysis incorporates multiple interaction mechanisms for a detailed material profile. The methods demonstrate Scalability by being extendable to higher dimensions for increased accuracy.

Enhanced Soft Tissue Contrast enables differentiation of similar-density soft tissues, which is critical for lymphatic imaging and other medical applications. The system provides a Quantitative Biomarker through noise-robust quantitative metrics such as PE/CS, PE/PP, and CS/PP ratios for objective tissue characterization and monitoring.

Improved Accuracy leverages the distinct energy dependencies of PE, CS, and PP for more accurate material identification. Simplicity and Scalability are achieved through utilization of cost-effective and scalable TFT backplane with FPGA and MCA signal processing.

The approach offers versatility by being applicable to X-ray, SPECT, PET, and visible photon imaging, enhancing the utility of the method across various imaging modalities. Early Cancer Detection offers potential through precise tissue differentiation.

Quantitative Analysis focuses on quantifying differences rather than just improving contrast-to-noise ratio (CNR), allowing for more objective and reproducible results, which is essential for high accuracy in medical imaging and other applications. The method is not limited to perovskite materials but can be applied to all multi-spectral photon counting detectors, enhancing its utility across various imaging systems in Broad Applicability.

### Conclusion

The incorporation of 2D and 3D vector analysis, including angle and direction measurements, multi-spectral energy integrating detectors with real-time noise correction, and neural networks trained on simulated data, significantly enhances the material characterization process by providing a more detailed and stable representation of photon and neutron interactions. This method improves the identification accuracy of materials with similar densities but distinct compositions, particularly in soft tissues. By leveraging these advanced techniques and the analogy of vector angles and directions acting like clock hands to describe materials, the disclosure holds great potential in medical imaging, security screening, material science, and other fields requiring precise material discrimination.

The method preserves tissue differentiation even under low-dose, high-noise conditions where conventional decomposition methods often falter, making it particularly valuable for clinical applications where radiation exposure must be minimized while maintaining diagnostic accuracy. The application of these AI models to existing multi-spectral photon counting detectors can re-analyze already available data, potentially improving the accuracy and effectiveness of current imaging systems.

### Alternative Embodiments

Clause 1. A method for identifying a material traversed by X-ray photons, comprising: (a) exposing a material to an X-ray source that emits a spectrum of photon energies; (b) detecting attenuated X-ray signals using a detector comprising at least four energy channels, including: (i) a first pair of energy channels configured to measure photon interactions predominantly in the photoelectric effect (PE) region, and (ii) a second pair of energy channels configured to measure photon interactions predominantly in the Compton scatter (CS) region; (c) calculating a first vector based on the difference in attenuated electron counts between the two PE energy channels, and a second vector based on the difference in attenuated electron counts between the two CS energy channels; (d) computing the angle between the first vector and the second vector; and (e) identifying the material based at least in part on the angular relationship between the PE and CS vectors.

Clause 2. A method for quantitative imaging using photons comprising: directing photons at a material or detecting photons emitted internally from the body; detecting and measuring the interactions of the photons with the material at two or more distinct energy channels; correcting the measured counts for dark current, noise, and detector drift using a real-time feedback loop; calculating the ratios of differences between the photoelectric effect, Compton scatter, and pair production across the energy channels; analyzing the slopes, angles, and directions of the lines representing these interactions; using the calculated ratios, slopes, angles, and directions to identify and quantify the material.

Clause 3. The method of clause 2 wherein the ratio of differences R(PE/CS) is defined as: R(PE/CS)=(ΔPE(E1)−ΔPE(E2))/(ΔCS(E1)−ΔCS(E2)).

Clause 4. The method of clause 2 wherein the ratio of differences R(PE/PP) is defined as: R(PE/PP)=(ΔPE(E1)−ΔPE(E2))/(ΔPP(E1)−ΔPP(E2)).

Clause 5. The method of clause 2 wherein the ratio of differences R(CS/PP) is defined as: R(CS/PP)=(ΔCS(E1)−ΔCS(E2))/(ΔPP(E1)−ΔPP(E2)).

Clause 6. The method of clause 2 wherein the slope S(PE/CS) is defined as: S(PE/CS)=d(PE)/d(CS).

Clause 7. The method of clause 2 wherein the slope S(PE/PP) is defined as: S(PE/PP)=d(PE)/d(PP).

Clause 8. The method of clause 2 wherein the slope S(CS/PP) is defined as: S(CS/PP)=d(CS)/d(PP).

Clause 9. The method of clause 2 wherein the photon interactions include Rayleigh scattering, and the ratios and slopes are used to enhance material differentiation in visible photon imaging techniques.

Clause 10. A method for quantitative imaging using photons further comprising the steps of: detecting photons emitted from radioactive tracers in PET imaging; calculating the ratios of differences between the photoelectric effect, Compton scatter, and pair production at different energy levels; using the calculated ratios and slopes to differentiate between cancerous and non-cancerous tissues with high precision.

Clause 11. A method for constructing multi-dimensional vectors comprising: selecting multiple pairs of energy bins across different interaction regions; extracting counts from each energy bin and correcting for noise and drift; calculating differences to form components of vectors; constructing two-dimensional (2D) and three-dimensional (3D) vectors representing material interactions; computing effective ratios, magnitudes, angles, and directions of the vectors.

Clause 12. The method of clause 1, wherein the identification of the material is based on a plurality of angular relationships, each computed from separate pairs of energy channels comprising: (a) a first photoelectric vector constructed from a first pair of energy channels in the photoelectric-dominated region, and a first Compton scatter vector constructed from a first pair of energy channels in the Compton scatter-dominated region; (b) a second photoelectric vector constructed from a second pair of energy channels in the photoelectric-dominated region, and a second Compton scatter vector constructed from a second pair of energy channels in the Compton scatter-dominated region, wherein the second pair of channels is non-overlapping with the first; (c) computing a first angle between the first photoelectric and first Compton scatter vectors, and a second angle between the second photoelectric and second Compton scatter vectors; (d) identifying the material based at least in part on the combination of the first and second angles.

Clause 13. A method for extending analysis to higher dimensions comprising: incorporating additional energy bins to capture more complex interactions; correcting all measurements for noise and drift using a real-time feedback loop; constructing higher-dimensional vectors and analyzing their angles and directions for improved material discrimination.

Clause 14. A system for quantitative imaging comprising: an X-ray source or a source of internal photon emission configured to direct photons at a material or detect photons emitted from within the body; a detector configured to measure the interactions of the photons with the material at multiple energy channels; a processor configured to calculate the ratios of differences between the photoelectric effect, Compton scatter, and pair production, and to analyze the slopes of the lines representing these interactions; software for processing the calculated ratios and slopes to identify and quantify the material.

Clause 15. The system of clause 14 wherein the processor is further configured to utilize the ratios of differences R(PE/CS), R(PE/PP), and R(CS/PP) and the slopes S(PE/CS), S(PE/PP), and S(CS/PP).

Clause 16. A system for material characterization comprising: a detector array configured to measure photon or neutron interactions at multiple energy bins; a real-time feedback loop for correcting measurements for dark current, noise, and detector drift; a processing unit configured to construct vectors, compute ratios, magnitudes, angles, and directions; software implementing neural networks trained on simulated data for analyzing the constructed vectors and their angles and directions; application of the system in medical imaging, security screening, or material science.

Clause 17. The system of clause 14 further comprising a source of visible photons and a detector for Rayleigh scattering for use in Raman spectroscopy applications.

Clause 18. The system of clause 14 further comprising integrating the method into a high-speed photon counting ASIC with multi-channel analyzers for each pixel.

Clause 19. A method comprising photon counting with multi-spectral energy integration and real-time noise correction: utilizing energy integration techniques to measure total energy deposited across energy bins; implementing a real-time feedback loop to correct for dark current, noise, and detector drift; reducing noise and improving signal-to-noise ratio; applying the integrated and corrected data to enhance material characterization; stabilizing vector angles and directions for accurate material identification.

Clause 20. A method for neural network integration with simulated data for enhanced material identification comprising: training neural networks on vectors constructed from simulated multi-energy bin counts, their angles, and directions; incorporating detector characteristics into simulations to accurately model responses; utilizing real-time noise correction to align actual measurements with simulated data; applying trained models to classify materials based on interaction signatures reflected in vector angles and directions.

Clause 21. The method of clause 1, wherein the identification of the material is performed by a machine learning model trained using both: (a) simulated data representing X-ray photon interactions with single-material paths; and (b) simulated data representing X-ray photon interactions with multi-material, path-integrated tissue geometries, wherein said simulated data comprises angular vector relationships derived from the differences in attenuated electron counts across paired energy channels, and wherein the machine learning model is configured to infer dominant material identity based on the resulting angular distortions between the photoelectric and Compton scatter vectors.

Clause 22. The system of clause 14 further comprising a machine learning module configured to analyze the ratios and slopes of photon interactions to improve material differentiation accuracy.

Clause 23. The system of clause 22 wherein the machine learning module is trained on datasets of photon interactions to recognize unique electronic signatures of different materials.

Clause 24. The method of clause 2 further comprising using the calculated ratios and slopes to train AI and machine learning algorithms for enhanced material differentiation accuracy.

Clause 25. The method of clause 2 further comprising using the calculated ratios and slopes to create unique electronic signatures for different materials, facilitating precise differentiation.

Clause 26. A method for enhanced tissue discrimination in medical imaging comprising: applying multi-dimensional vector analysis, angle, and direction measurements to imaging data; correcting measurements for noise and drift using a real-time feedback loop; differentiating tissues based on unique interaction signatures and vector trajectories; utilizing the method for improved diagnostic accuracy.

Clause 27. A system for real-time material characterization in medical imaging comprising: an X-ray CT or neutron imaging device configured to irradiate biological tissues at multiple energy levels; a high-speed detector array configured to measure interaction probabilities for different photon or neutron interactions; a processing unit configured to perform dual-slope analysis on the measured data; an AI module trained to enhance diagnostic accuracy by identifying tissue abnormalities based on the dual-slope data.

Clause 28. The system of clause 27 further comprising a user interface that provides real-time feedback to medical practitioners, highlighting areas of concern and suggesting potential diagnoses.

Clause 29. The method of clause 2 further comprising integrating multi-spectral and hyper-spectral imaging techniques to enhance the resolution and accuracy of the dual-slope analysis.

Clause 30. A method for application in security screening comprising: using vector analysis of photon and neutron interactions, including angle and direction measurements, to detect and identify hazardous materials; implementing real-time noise correction to ensure accurate measurements; integrating the method into security scanning systems for enhanced detection capabilities.

Clause 31. A method for enhancing security screening comprising: directing photons or neutrons at a material or object; detecting and measuring the interactions of the photons or neutrons with the material at multiple energy channels; calculating the ratios of differences between various interaction mechanisms across the energy channels; analyzing the slopes of the lines representing these interactions; using the calculated ratios and slopes to identify and quantify the material for security purposes.

Clause 32. The method of clause 31 further comprising integrating AI algorithms to enhance detection accuracy and reduce false positives in security screening applications.

Clause 33. A method for non-destructive testing comprising: applying the vector analysis and angle and direction measurements to assess internal structures of materials without causing damage; correcting measurements for noise and drift to prevent misinterpretation; identifying structural anomalies based on interaction signatures and changes in vector trajectories.

Clause 34. A method for enhancing non-destructive testing (NDT) in industrial applications comprising: directing photons or neutrons at a component or structure; measuring the interactions of the photons or neutrons with the component at multiple energy levels; calculating the interaction ratios and slopes for each type of interaction; comparing the calculated ratios and slopes with reference data to identify structural or compositional anomalies; using AI algorithms to enhance anomaly detection accuracy and predict potential failure points.

Clause 35. The method of clause 34 further comprising generating detailed imaging reports that highlight areas of concern and provide recommendations for further investigation or remediation.

Clause 36. A method for material characterization using neutron interactions comprising: directing neutrons at a material; detecting and measuring neutron interactions at multiple energy channels; correcting the measured counts for noise and drift using a real-time feedback loop; calculating differences and constructing vectors from neutron interaction counts; computing effective ratios, magnitudes, angles, and directions for material identification; analyzing the slopes, angles, and directions of the lines representing these interactions.

Clause 37. A method for quantitative imaging using neutrons comprising: directing neutrons at a material; detecting and measuring the interactions of the neutrons with the material at two or more distinct energy channels; calculating the ratios of differences between elastic scattering, inelastic scattering, neutron capture, and neutron-induced fission across the energy channels; analyzing the slopes of the lines representing the elastic scattering, inelastic scattering, neutron capture, and neutron-induced fission interactions; using the calculated ratios and slopes to identify and quantify the material.

Clause 38. The method of clause 37 wherein the ratio of differences R(elastic/inelastic) is defined as: R(elastic/inelastic)=(Δelastic(E1)−Δelastic(E2))/(Δinelastic(E1)−Δinelastic(E2)).

Clause 39. The method of clause 37 wherein the ratio of differences R(elastic/capture) is defined as: R(elastic/capture)=(Δelastic(E1)−Δelastic(E2))/(Δcapture(E1)−Δcapture(E2)).

Clause 40. The method of clause 37 wherein the ratio of differences R(elastic/fission) is defined as: R(elastic/fission)=(Δelastic(E1)−Δelastic(E2))/(Δfission(E1)−Δfission(E2)).

Clause 41. The method of clause 37 wherein the slope S(elastic/inelastic) is defined as: S(elastic/inelastic)=d(elastic)/d(inelastic).

Clause 42. The method of clause 37 wherein the slope S(elastic/capture) is defined as: S(elastic/capture)=d(elastic)/d(capture).

Clause 43. The method of clause 37 wherein the slope S(elastic/fission) is defined as: S(elastic/fission)=d(elastic)/d(fission).

Clause 44. A system for quantitative imaging using neutrons comprising: a neutron source configured to direct neutrons at a material; a detector configured to measure the interactions of the neutrons with the material at multiple energy channels; a processor configured to calculate the ratios of differences between elastic and inelastic scattering, neutron capture, and neutron-induced fission, and to analyze the slopes of the lines representing these interactions; software for processing the calculated ratios and slopes to identify and quantify the material.

Clause 45. The system of clause 44 wherein the processor is further configured to utilize the ratios of differences R(elastic/inelastic), R(elastic/capture), and R(elastic/fission) and the slopes S(elastic/inelastic), S(elastic/capture), and S(elastic/fission).

Clause 46. The system of clause 44 further comprising a machine learning module configured to analyze the ratios and slopes of neutron interactions to improve material differentiation accuracy.

Clause 47. The system of clause 46 wherein the machine learning module is trained on datasets of neutron interactions to recognize unique electronic signatures of different materials.

Clause 48. The method of clause 37 further comprising integrating the method into a high-speed neutron counting detector with multi-channel analyzers for each voxel.

Clause 49. The method of clause 37 further comprising using the calculated ratios and slopes to create unique electronic signatures for different materials, facilitating precise differentiation.

Clause 50. The method of clause 37 further comprising using the calculated ratios and slopes to train AI and machine learning algorithms for enhanced material differentiation accuracy.

Clause 51. A method for improving the accuracy of multi-spectral photon counting detectors comprising: re-analyzing existing datasets with the dual-slope technique to calculate ratios and slopes of PE, CS, and PP interactions; integrating AI algorithms to recognize patterns and improve material differentiation.

Clause 52. A system for improving the accuracy of multi-spectral neutron counting detectors comprising: re-analyzing existing datasets with the dual-slope technique to calculate ratios and slopes of elastic, inelastic, capture, and fission interactions; integrating AI algorithms to recognize patterns and improve material differentiation.

Clause 53. A method for optimizing the performance of multi-spectral photon and neutron counting detectors comprising: collecting interaction data from a variety of materials using the detectors at multiple energy levels; performing dual-slope analysis to calculate interaction ratios and slopes for the collected data; training AI algorithms on the analyzed data to improve the detectors' material differentiation capabilities; continuously updating the detectors' calibration and processing algorithms based on new data and AI insights.

Clause 54. The method of clause 53 wherein the optimized detectors are used in a variety of applications, including medical imaging, security screening, industrial NDT, and scientific research.

Clause 55. A system for automated material identification comprising: a source of photons or neutrons configured to irradiate a material; a detector array configured to measure the interactions of the photons or neutrons with the material at multiple energy levels; a processing unit configured to calculate interaction ratios and slopes and to compare them against a database of known material signatures; an AI module trained to refine material identification accuracy based on iterative learning from new data.

Clause 56. The system of clause 55 wherein the AI module is further configured to update the material signature database in real-time as new materials are characterized.

Clause 57. The system of clause 55 wherein the processing unit and AI module are configured to operate in a cloud-based environment, allowing for scalable data processing and storage.

Clause 58. A method for quantitative material differentiation comprising: using a photon or neutron source to irradiate a material; measuring the interaction probabilities of the photons or neutrons with the material at multiple energy levels; calculating the interaction ratios and slopes for each type of interaction; analyzing the calculated ratios and slopes to identify unique signatures corresponding to the material's electronic or nuclear structure; using the unique signatures to differentiate and identify the material.

Clause 59. The method of clause 58 wherein the calculated interaction ratios and slopes are used to create a comprehensive database of material signatures for use in various applications, including medical imaging, security screening, and material science.

Clause 60. A method for quantitative material characterization using dual-slope analysis comprising: irradiating a material with photons or neutrons at multiple energy levels; measuring the interaction probabilities for different photon or neutron interactions at each energy level; calculating the ratios of differences and slopes for the measured interactions; analyzing the dual-slope data to create a quantitative profile of the material's composition and structure; comparing the profile with a database of known material profiles to accurately identify the material.

Clause 61. The method of clause 60 wherein the dual-slope analysis is applied to characterize biological tissues, providing enhanced diagnostic capabilities in medical imaging.

Clause 62. The method of clause 60 wherein the dual-slope analysis is applied to security screening, allowing for the differentiation of hazardous materials from benign substances with high accuracy.

Clause 63. The method of clause 60 wherein the dual-slope analysis is used to characterize geological samples, providing valuable data for resource exploration and environmental studies.

Clause 64. A display system for visualizing material composition, comprising: (a) a processing module configured to receive input data comprising vector-based material identity information derived from photon interaction ratios across energy bins or spectral channels; (b) a composition visualization module configured to generate a two-dimensional or three-dimensional image wherein spatial locations are color-coded based on identified material type; (c) an optional interface layer allowing said composition image to be displayed independently or superimposed onto a conventional grayscale or anatomical image; (d) wherein the system supports input across a plurality of photon wavelength domains, including ionizing and non-ionizing spectra.

Clause 65. The method of clause 2 further comprising applying the method to visible photon interactions, such as Rayleigh scattering, for material differentiation in Raman spectroscopy.

Clause 66. The method of clause 2 further comprising using addition to combine photon counts from multiple energy channels, wherein adding the photon counts from channel 1 and channel 2 for the photoelectric effect provides a total attenuation measure that can be compared to that of Compton scattering to analyze the density of the material.

Clause 67. The method of clause 2 wherein any mathematical expression can be used to create a difference in vector angles between two or more interaction mechanisms across two or more energy channels, allowing for a wide range of mathematical approaches including derivatives, differentiations, and other mathematical operations to calculate the vector angles and ratio-metric values.

### References

All patents, patent applications, publications, and other references cited herein are hereby incorporated by reference in their entireties to the extent they are not inconsistent with the explicit teachings of this specification.
Knoll, G. F. (2010). Radiation Detection and Measurement. Wiley.
Jan, S., et al. (2004). GATE: a simulation toolkit for PET and SPECT. Physics in Medicine & Biology, 49(19), 4543.
Agostinelli, S., et al. (2003). GEANT4—a simulation toolkit. Nuclear Instruments and Methods in Physics Research Section A, 506(3), 250-303.
Litjens, G., et al. (2017). A survey on deep learning in medical image analysis. Medical Image Analysis, 42, 60-88.
McCollough C H, Leng S, Yu L, Fletcher J G. Dual- and multi-energy CT: principles, technical approaches, and clinical applications. Radiology. 2015; 276(3):637-653.
Taguchi K, Iwanczyk J S. Vision 20/20: Single photon counting x-ray detectors in medical imaging. Med Phys. 2013; 40(10):100901.
Elmore J G, Barton M B, Moceri V M, Polk S, Arena P J, Fletcher S W. Ten-year risk of false positive screening mammograms and clinical breast examinations. N Engl J Med. 1998; 338(16):1089-1096.
Hubbard R A, Kerlikowske K, Flowers C I, et al. Cumulative probability of false-positive recall or biopsy recommendation after 10 years of screening mammography: a cohort study. Ann Intern Med. 2011; 155(8):481-492.
Gennaro G, Toledano A, di Maggio C, et al. Digital breast tomosynthesis versus digital mammography: a clinical performance study. Eur Radiol. 2010; 20(7):1545-1553.
Bernardi D, Macaskill P, Pellegrini M, et al. Breast cancer screening with tomosynthesis (3D mammography) with or without synthetic 2D mammography: a population-based prospective trial. Lancet Oncol. 2016; 17(8):1105-1113.
Ong M S, Mandl K D. National expenditure for false-positive mammograms and breast cancer overdiagnoses estimated at $4 billion a year. Health Aff (Millwood). 2015; 34(4):576-583.
Smith J D, Johnson B I, Mescher M C, De Moraes C M. A plant parasite uses light cues to detect differences in host-plant proximity and architecture. Plant Cell Environ. 2021; 44(4):1169-1180.
Johnson B I, De Moraes C M, Mescher M C. Manipulation of light spectral quality disrupts host location and attachment by parasitic Cuscuta pentagona under greenhouse conditions. Botany. 2016; 94(9):813-820.
Benvenuti S, Dinelli G, Bonetti A, Catizone P. Germination ecology, emergence, and host detection in Cuscuta campestris. Weed Res. 2005; 45(4):270-278.
Koch A M, Binder C, Sanders I R. Does UV-B affect the parasitic relationship between Cuscuta europea and its host Urtica dioica? Weed Res. 2004; 44(3):250-258.
Shen H, Luong P, Gage D A, Durst R W. Investigating the role of light in dodder (Cuscuta indecora) host-plant specificity. Weed Sci. 2003; 51(2):281-286.
Orr G L, Haidar M A, Orr D A. Small seed dodder (Cuscuta planiflora) phototropism towards far-red when in white light. Weed Sci. 1996; 44(2):233-240.
Tada Y, Sugai M, Mori T, Takahashi H. Tissue and cellular localization of phytochrome in a holoparasitic flowering plant, Cuscuta japonica (Convolvulaceae). J Plant Res. 1996; 109(4):369-376.
Knoll G F. Radiation Detection and Measurement. 4th ed. John Wiley & Sons; 2010.
Schlomka J P, Roessl E, Dorscheid R, et al. Experimental feasibility of multi-energy photon-counting K-edge imaging in pre-clinical computed tomography. Phys Med Biol. 2008; 53(15):4031-4047.
Roessl E, Proksa R. K-edge imaging in x-ray computed tomography using multi-bin photon counting detectors. Phys Med Biol. 2007; 52(15):4679-4696.
Yu Z, Leng S, et al. Evaluation of conventional imaging performance in a research whole-body CT system with a photon-counting detector array. Phys Med Biol. 2016; 61(4):1572-1595.
USPTO Issued Patent Number: U.S. Pat. No. 11,841,468, “Photon Sensor”, Filed Oct. 12, 2021.
Shirley K, Novoselov K, Nie W, et al. “High-Efficiency X-ray Sensing with Recyclable Perovskite-Graphene Heterostructured Transistors”. ΔCS Energy Letters, 2023, 8 (7), 3161-3170.
USPTO Continuation Non-Provisional Patent Application Number: Ser. No. 17/559,731, “Photon Sensor”, Filed Dec. 22, 2021.
Gomez-Fernandez, M. et al. Isotope Identification Using Deep Learning: An Explanation. NIM A, 2020, 164925.
Gomez-Fernandez, M. et al. Nuclear Energy System's Behavior and Decision Making Using Machine Learning. Nuclear Eng. & Design, 2017.
Gomez-Fernandez, M. et al. Status of Research and Development of Learning-Based Approaches in Nuclear Science and Engineering: A Review. Nuclear Eng. & Design, 2019.

1-17. (canceled)

18. A method for identifying a material through which photons have traversed, said method comprising:
receiving two or more signal pair sets, wherein a first signal pair corresponds to a first pair of energy resolved channels associated with a first photon interaction region, and a second signal pair corresponds to a second pair of energy resolved channels associated with a second photon interaction region,
wherein the first photon interaction region is different from the second photon interaction region;
forming a first vector from the first signal pair and forming a second vector from the second signal pair;
determining a first angular direction and magnitude for the first vector and determining a second angular direction and magnitude for the second vector; and
identifying a material using an angular signature defined by the relationship between the first vector and the second vector.

19. The method of claim 18, wherein the first pair of energy resolved channels corresponds to photon energies predominantly associated with photoelectric effect and the second pair of energy resolved channels corresponds to photon energies predominantly associated with Compton scattering.

20. The method of claim 18, wherein the first vector is formed using differences in signal counts between two photoelectric-dominated bins, and the second vector is formed using differences in signal counts between two Compton-dominated bins.

21. The method of claim 18, wherein identifying the material comprises matching the angular signature to a known angular signature of a database associating a plurality of known angular signatures to a plurality of materials.

22. The method of claim 18, wherein the first vector and the second vector are encoded using spherical coordinates to preserve directional relationships in multi-dimensional angular space.

23. The method of claim 18, wherein the angular signature comprises a position in a multi-dimensional angular space unique to a material.

24. The method of claim 18, wherein the first vector and the second vector are positioned along orthogonal axes originating from a common (0,0) coordinate, and the method comprises computing a resultant vector from the first vector and the second vector to define a unique location in two-dimensional or three-dimensional vector space for material identification.

25. A method for classifying a material based on multi-energy photon interactions, said method comprising:
receiving two or more signal pair sets,
wherein a first signal pair corresponds to a first pair of energy resolved channels associated with a first photon interaction region, and a second signal pair corresponds to a second pair of energy resolved channels associated with a second photon interaction region,
wherein the first photon interaction region is different from the second photon interaction region;
forming a first vector from the first signal pair and forming a second vector from the second signal pair;
determining a first angular direction and magnitude for the first vector and a second angular direction and magnitude for the second vector;
generating an angular signature defined by the relationship between the first vector and the second vector;
providing the angular signature as input to a trained machine learning model; and
receiving as output a classification of the material.

26. The method of claim 25, wherein the trained machine learning model is produced by training a physics informed neural network using simulated angular vector data derived from Monte Carlo simulations.

27. The method of claim 25, wherein the trained machine learning model is produced by training the physics informed neural network trained using single-material and multi-material path integrated simulations to account for layered tissue geometries.

28. The method of claim 25, further comprising correcting the first energy-resolved signal count and the second energy resolved signal count using a real-time feedback loop configured to compensate for dark current, noise, and detector drift.

29. The method of claim 25, wherein the output comprises a probability distribution across candidate materials and includes a confidence metric.

30. The method of claim 25, further comprising normalizing the angular direction to a unit hypersphere prior to the inputting step to remove dependency on total photon flux.

31. The method of claim 25, comprising dynamically adjusting energy binning thresholds in real time based on feedback from Poisson noise, detector dark current, signal to noise ratio, or spectral drift correction inputs.

32. A photon detection system comprising:
a sensor configured to segment incoming photons into two or more energy resolved channels,
wherein a first signal pair is obtained from a first pair of energy resolved channels associated with a first photon interaction region, and a second signal pair is obtained from a second pair of energy resolved channels associated with a second photon interaction region,
wherein the first photon interaction region is different from the second photon interaction region;
analog circuitry configured to form a first vector from the first signal pair and a second vector from the second signal pair;
a comparator or equivalent hardware component configured to determine a first angular direction and magnitude for the first vector and a second angular direction and magnitude for the second vector, and to generate an angular signature defined by the relationship between the first vector and the second vector; and
a processor or hardware lookup configured to identify a material based on the angular signature.

33. The system of claim 32, wherein the sensor comprises a direct conversion material selected from the group consisting of perovskite, cadmium telluride, cadmium zinc telluride, silicon, gallium arsenide, and amorphous selenium.

34. The system of claim 32, wherein the analog circuitry includes a differential amplifier configured to produce a voltage output proportional to the angular difference between energy bin signals.

35. The system of claim 32, further comprising a dynamic energy binning module configured to adjust the energy threshold settings of the bins based on real-time spectral input.

36. The system of claim 32, wherein the processor or hardware lookup identifies the material without analog-to-digital conversion by directly mapping angular outputs to material signatures in hardware.

37. The system of claim 32, wherein the system is configured to output a material identity label that is used to produce a composition image overlaid onto a grayscale anatomical scan.

38. The system of claim 32, further comprising a real-time feedback loop implemented via an artificial intelligence module, the feedback loop configured to correct for detector drift, dark current, and photon source noise, such that the processed signal used for vector formation represents only the true attenuated photon interactions.
